(19) United States
(12) Patent Application Publication
(10) Pub. No.: US 2026/0277266 A1
(43) Pub. Date: Sep. 17, 2026

(54) UNIVERSAL LINEAR INTENSITY TRANSFORMATIONS USING SPATIALLY-INCOHERENT DIFFRACTIVE PROCESSORS

(71) Applicant: THE REGENTS OF THE UNIVERSITY OF CALIFORNIA, Oakland, CA (US)

(72) Inventors: Aydogan Ozcan, Los Angeles, CA (US); Md Sadman Sakib Rahman, Los Angeles, CA (US); Xilin Yang, Los Angeles, CA (US)

(73) Assignee: THE REGENTS OF THE UNIVERSITY OF CALIFORNIA, Oakland, CA (US)

(21) Appl. No.: 19/165,564

(22) PCT Filed: Feb. 16, 2024
(86) PCT No.: PCT/US2024/016060

§ 371 Date: Sep. 15, 2025

Related U.S. Application Data
(60) Provisional application No. 63/491,714, filed on Mar. 22, 2023.

(51) Int. Cl. G06E 3/00; G06N 3/067

(52) U.S. Cl. CPC G06E 3/005; G06N 3/067

(57) ABSTRACT

Under spatially-coherent light, a diffractive optical network or processor composed of structured surfaces can be designed to perform any arbitrary complex-valued linear transformation between its input and output fields-of-view (FOVs) if the total number (N) of optimizable phase-only diffractive features is ≥~2NᵢNₒ, where Nᵢ and Nₒ refer to the number of useful pixels at the input and the output FOVs, respectively. Here, a spatially-incoherent diffractive optical processor is disclosed that can approximate any arbitrary linear transformation in time-averaged intensity between its input and output FOVs. In other embodiments, the diffractive optical network or processor executes complex-valued information processing for executing arbitrary complex-valued linear transformations using spatially incoherent light. Spatially-incoherent diffractive networks will be broadly useful for designing all-optical visual processors that can work with incoherent, under natural light.

### RELATED APPLICATION

This application claims priority to U.S. Provisional Patent Application No. 63/491,714 filed on Mar. 22, 2023 which is hereby incorporated by reference. Priority is claimed pursuant to 35 U.S.C. § 119 and any other applicable statute.

### STATEMENT REGARDING FEDERALLY SPONSORED RESEARCH AND DEVELOPMENT

This invention was made with government support under DE-SC0023088 awarded by the U.S. Department of Energy. The government has certain rights in the invention.

### TECHNICAL FIELD

The technical field generally relates to a diffractive networks or diffractive processors that are able to successfully operate with spatially-incoherent light. In particular, the technical field relates to a spatially-incoherent diffractive network or diffractive processor that can be trained to all-optically perform any arbitrary linear intensity transformation between its input and output.

### BACKGROUND

Spatial information processing with free-space optics has been widely explored and predates the proliferation of electronic computing. Spatial filtering, matrix multiplication, Fourier transform, implementation of neural networks and other information processing operations have been realized with free-space optics. The emergence of metasurfaces in the last decades, together with the search for neural network accelerators for artificial intelligence, has reignited the interest in free-space-based analog optical information processing. The inherent transformation of optical fields as they propagate through free space, known as diffraction, together with the ability for wavefront modulation with compact hardware, makes low-cost and passive spatial information processing at the speed of light propagation possible. Diffractive optics also enables the design of intricate optical elements and structures capable of shaping or controlling the light propagation for applications such as microscopy and imaging. In recent years, diffractive optical networks comprising a set of spatially engineered surfaces to perform computation through passive light-matter-interaction have emerged as powerful all-optical processors. Designed utilizing deep learning, such coherent diffractive optical processors have demonstrated versatile applications, including statistical inference as well as deterministic tasks across the spectrum from terahertz to near-infrared and visible.

Information processing with a diffractive network involves local modulation of the amplitude and/or the phase of the incident optical wave by structured surfaces containing diffractive neurons/features, each with a lateral size of ~λ/2, where λ is the wavelength of the spatially coherent illumination light. The entire propagation of a spatially coherent wave from the input plane to the output FOV comprises such optical modulations by K spatially optimized diffractive surfaces, which in total contain N independent diffractive features (for example, evenly distributed over the K diffractive surfaces). These N diffractive features represent the complex-valued transmission coefficients, forming the independent degrees of freedom of the diffractive processor, which can be optimized to all-optically execute different tasks. It was shown that a spatially coherent diffractive optical network could be trained to perform any arbitrary complex-valued linear transformation between its input and output FOVs if N≥NᵢNₒ, where Nᵢ and Nₒ refer to the number of useful (diffraction-limited) pixels at the input and the output FOVs. For a phase-only diffractive network where the transmission coefficients of the diffractive features of each structured surface only modulate the phase information of light, the requirement for universal linear transformations increases to N≥2NᵢNₒ due to the reduced degrees of freedom that can be optimized independently.

For a given complex-valued linear transformation that a coherent diffractive network is designed to approximate, any arbitrary point on the input plane defined by (m′, n′) will result in a unique complex-valued coherent point spread function (h) at the output FOV defined by (m, n). This 4-dimensional complex-valued function, h(m, n; m′, n′), that maps the input and output FOVs represents a spatially varying coherent point spread function (PSF). Stated differently, unlike traditional spatially invariant imaging systems, a coherent diffractive optical network provides a framework to approximate any arbitrary h(m, n; m′, n′) that corresponds to an arbitrarily selected complex-valued linear transformation between its input and output FOVs. It was also shown that different/independent complex-valued linear transformations could be multiplexed in a single spatially coherent diffractive processor by utilizing polarization and wavelength diversity. All of these earlier studies on universal linear transformations implemented in free-space through diffractive processors were based on spatially coherent illumination.

### SUMMARY

Here, the demonstration of universal linear transformations in optical intensity performed under spatially-incoherent monochromatic illumination of an input FOV is demonstrated. Using spatially-incoherent light, a diffractive optical processor can perform any arbitrary linear transformation of time-averaged intensities between its input and the output FOVs. Numerical analyses revealed that phase-only diffractive optical processors with a shallow architecture (for example, having a single trainable diffractive surface) are unable to accurately approximate an arbitrary intensity transformation irrespective of the total number (N) of diffractive features available for optimization; on the contrary, phase-only diffractive optical processors with deeper architectures (one diffractive layer following others) can perform an arbitrary intensity linear transformation using spatially-incoherent illumination with a negligible error when N≥2NᵢNₒ. Spatially-incoherent diffractive optical processors can perform linear intensity transformations at different illumination wavelengths, i.e., simultaneously perform the same linear transformation or different linear transformations at different wavelengths under spatially-incoherent illumination. Finally, the design of a spatially-incoherent diffractive network is disclosed for all-optical classification of handwritten digits, achieving 95.04% blind testing accuracy.

The diffractive optical network or processor is important for all-optical information processing and visual computing systems that use spatially and temporally incoherent light, such as in natural scenes. The presented framework can also find unique applications in computational microscopy and incoherent imaging through point spread function engineering.

In one embodiment, a diffractive optical network or processor includes a plurality of optically transmissive and/or reflective substrate layer(s) arranged in an optical path, each of the optically transmissive and/or reflective substrate layer(s) comprising a plurality of physical features formed on or within the one or more optically transmissive or reflective substrate layer(s) and having different transmission and/or reflection properties as a function of the lateral coordinates across each substrate layer, wherein the plurality of optically transmissive and/or reflective substrate layer(s) are configured to receive an input optical signal or data comprising spatially-incoherent and/or temporally-incoherent light and wherein the plurality of optically transmissive and/or reflective substrate layer(s) generate an output optical signal or data that approximates a target linear transformation of the input optical signal or data. The plurality of optically transmissive and/or reflective substrate layer(s) are designed during a training phase with training intensity patterns or images to define or optimize the plurality of physical features formed on or within the one or more optically transmissive or reflective substrate layer(s) to generate the output optical signal or data that approximate the target linear transformation of the input optical signal or data.

In another embodiment, a method of using a diffractive optical network or processor includes providing a plurality of optically transmissive and/or reflective substrate layer(s) arranged in an optical path, each of the optically transmissive and/or reflective substrate layer(s) comprising a plurality of physical features formed on or within the one or more optically transmissive or reflective substrate layer(s) and having different transmission and/or reflection properties as a function of the lateral coordinates across each substrate layer, wherein the plurality of optically transmissive and/or reflective substrate layer(s) are configured to receive an input optical signal or data comprising spatially-incoherent and/or temporally-incoherent light and wherein the plurality of optically transmissive and/or reflective substrate layer(s) generate an output optical signal or data that approximates a target linear transformation of the input optical signal or data. The input optical signal or data is input to the plurality of optically transmissive and/or reflective substrate layer(s). The output optical signal or data is captured with one or more image sensors or optoelectronic detectors or projecting the output optical signal onto a surface or volume.

In another embodiment, a diffractive optical network or processor for performing a complex-valued target linear transformation of an input optical signal or data includes a plurality of optically transmissive and/or reflective substrate layer(s) arranged in an optical path, each of the optically transmissive and/or reflective substrate layer(s) including a plurality of physical features formed on or within the one or more optically transmissive or reflective substrate layer(s) and having different transmission and/or reflection properties as a function of the lateral coordinates across each substrate layer, wherein the plurality of optically transmissive and/or reflective substrate layer(s) are configured to receive input optical signal(s) or data comprising spatially-incoherent light that maps complex-valued data to an optical intensity-based representation at an input field-of-view (FOV) of the diffractive optical network and wherein the plurality of optically transmissive and/or reflective substrate layer(s) generate encrypted output optical signal(s) or data at an output field-of-view (FOV). One or more image sensors or optoelectronic detectors are disposed at the output field-of-view and configured to receive the output optical signal(s) or data at the output FOV. The diffractive optical network or processor includes a computing device or circuitry configured to map intensity data obtained by the one or more image sensors or optoelectronic detectors at the output FOV into a complex-valued signal(s) or data that approximate the target linear transformation of the input optical signal or data.

In another embodiment, a diffractive optical network or processor for performing a complex-valued target linear transformation of an input optical signal or data includes a plurality of optically transmissive and/or reflective substrate layer(s) arranged in an optical path, each of the optically transmissive and/or reflective substrate layer(s) including a plurality of physical features formed on or within the one or more optically transmissive or reflective substrate layer(s) and having different transmission and/or reflection properties as a function of the lateral coordinates across each substrate layer, wherein the plurality of optically transmissive and/or reflective substrate layer(s) are configured to receive a digitally encrypted complex optical image comprising spatially-incoherent light that maps complex-valued data to an optical intensity-based representation at an input field-of-view (FOV) of the diffractive optical network and wherein the plurality of optically transmissive and/or reflective substrate layer(s) generate a decrypted output optical signal or data at an output field-of-view (FOV). One or more image sensors or optoelectronic detectors are disposed at the output field-of-view and configured to receive the output optical signal or data at the output (FOV). The diffractive optical network or processor includes a computing device or circuitry configured to map intensity data obtained by the one or more image sensors or optoelectronic detectors at the output FOV into a complex-valued signal(s) or data that approximate the target linear transformation of the input optical signal or data.

### BRIEF DESCRIPTION OF THE DRAWINGS

FIG. 1A schematically illustrates a diffractive optical network or processor according to one embodiment. The diffractive optical network or processor is operating in transmission mode where the spatially and/or temporally-incoherent light transmits through the substrate/diffraction layers.

FIG. 1B schematically illustrates a diffractive optical network or processor according to one embodiment. The diffractive optical network or processor is operating in reflection mode where the spatially and/or temporally-incoherent light reflects off the substrate/diffraction layers.

FIG. 1C illustrates a flowchart illustrating how a digital model of the diffractive sensor is first digitally trained to define or optimize the plurality of physical features formed on or within the one or more optically transmissive or reflective substrate layer(s) to generate the output optical signal or data that approximates the target linear transformation of the input optical signal or data. Once the digital model of the diffractive optical network or processor is trained, a physical embodiment of the diffractive sensors is than manufactured and used.

FIG. 2 illustrates a single substrate layer of the diffractive optical network or processor. The substrate layer may be made from a material that is optically transmissive (for transmission mode) or an optically reflective material (for reflective mode). The substrate layer, which may be formed as a substrate or plate in some embodiments, has surface features formed across the substrate layer. The surface features form a patterned surface (e.g., an array) having different valued transmission (or reflection) properties as a function of lateral coordinates across each substrate layer. These surface features act as artificial “neurons” that connect to other “neurons” of other substrate layers of the optical neural network through optical diffraction (or reflection) and alter the phase and/or amplitude of the light wave.

FIG. 3 schematically illustrates a cross-sectional view of a single substrate layer of a diffractive optical network or processor according to one embodiment. In this embodiment, the surface features are formed by adjusting the thickness of the substrate layer that forms the optical neural network. These different thicknesses may define peaks and valleys in the substrate layer that act as the artificial “neurons.”

FIG. 4 schematically illustrates a cross-sectional view of a single substrate layer of a diffractive optical network or processor according to another embodiment. In this embodiment, the different surface features are formed by altering the material composition or material properties of the single substrate layer at different lateral locations across the substrate layer. This may be accomplished by doping the substrate layer with a dopant or incorporating other optical materials into the substrate layer. Metamaterials or plasmonic structures may also be incorporated into the substrate layer.

FIG. 5 schematically illustrates a cross-sectional view of a single substrate layer of a diffractive optical network or processor according to another embodiment. In this embodiment, the substrate layer is reconfigurable in that the optical properties of the various artificial neurons may be changed, for example, by application of a stimulus (e.g., electrical current or field). An example includes spatial light modulators (SLMs) which can change their optical properties. In this embodiment, the neuronal structure is not fixed and can be dynamically changed or tuned as appropriate. This embodiment, for example, can provide a learning diffractive network or a changeable diffractive network that can be altered on-the-fly (e.g., over time) to improve the performance, compensate for aberrations, or even change another task.

FIG. 6A is a schematic of a diffractive network formed by K=5 diffractive surfaces that all-optically perform a linear transformation of intensity between the input and output FOVs. The N diffractive features are distributed evenly among the K=5 surfaces.

FIG. 6B illustrates an arbitrary Nₒ×Nᵢ matrix A, representing the target intensity transformation to be performed all-optically by the diffractive network. Here Nᵢ=8² and Nₒ=8² are the number of pixels at the input and the output FOVs of the diffractive network, respectively.

FIG. 6C illustrates the expectation value of the MSE between the all-optical output intensity o′ and the ground-truth output intensity o, as a function of N for different diffractive networks trained using the indirect approach. To simulate the incoherent propagation of intensity for each test input, N_{φ,te}=20000 was used.

FIG. 6D illustrates a graph showing the dependence of the calculated output MSE on N_{o,te}, demonstrated for network #1E of FIG. 6C. The right y-axis shows the expectation value of the residual magnitude of

$$\frac{1}{{N}_{φ , te}} {\sum }_{i = 1}^{{N}_{φ , te}} {e}^{j {θ}_{i}} ,$$

where θᵢ~Uniform(0, 2π).

FIG. 7 illustrates the all-optical linear transformations of intensity, Â, performed under spatially-incoherent illumination, by five of the diffractive network designs shown in FIG. 6C, together with the corresponding error matrices with respect to the target transformation, ε=|A−Â|. Here |·| denotes elementwise operation. The means of the error matrix elements are listed in the table on the right.

FIG. 8 illustrates the all-optical linear transformation of structured intensity patterns such as letters U, C, L, and A by the same diffractive networks as in FIG. 7, accompanied by the patterns resulting from the numerical inverse mapping of the all-optical outputs through multiplication by A⁻¹.

FIG. 9 is the same as FIG. 6, except for the test intensity patterns formed by closely separated lines and points.

FIG. 10 illustrates the effect of the diffractive network's depth, i.e., the number of diffractive surfaces (K), on the approximation performance for an arbitrary intensity linear transformation under spatially-incoherent illumination. All-optical linear transformations of intensity, Â, performed by four diffractive network designs with approximately equal N and increasing K, are shown, together with the corresponding error matrices with respect to the target transformation, i.e., ε=|A−Â|. Here |·| denotes elementwise operation. The mean values of the error matrix elements are listed in the table on the right.

FIGS. 11A-11B illustrate all-optical linear transformation of intensity under spatially-incoherent illumination, by diffractive networks trained using the direct approach. FIG. 11A illustrates the expectation value of the MSE between the all-optical output intensity o′ and the ground-truth output intensity o, as a function of N for different diffractive networks trained using the direct approach. FIG. 11B shows the dependence of the calculated output MSE on N_{φ,te}, demonstrated for network #2E of FIG. 11A. The right y-axis shows the expectation value of the residual magnitude of

$$\frac{1}{{N}_{φ , te}} {\sum }_{i = 1}^{{N}_{φ , te}} {e}^{j {θ}_{i}} ,$$

where θᵢ~Uniform(0, 2π).

FIG. 12 illustrates all-optical linear transformations of intensity, Â, performed under spatially-incoherent illumination by five of the diffractive network designs shown in FIG. 11A, together with the corresponding error matrices with respect to the target transformation, ε=|A−Â|. Here |·| denotes elementwise operation. The mean values of the error matrix elements are listed in the table on the right.

FIG. 13 illustrates the all-optical linear transformation of structured intensity patterns such as letters U, C, L, and A by the same diffractive networks as in FIG. 12, accompanied by the patterns resulting from the numerical inverse mapping of the all-optical outputs through multiplication by A⁻¹.

FIG. 14 is the same as FIG. 13, except for the test intensity patterns formed by closely separated lines and points.

FIGS. 15A-15B illustrate the approximation of an arbitrary non-invertible linear transformation (A) of intensity, under spatially-incoherent illumination, by a diffractive network (K=5, N=5×58²) trained using the indirect approach. FIG. 15A shows the target transformation A, the all-optical intensity transformation Â performed by the trained diffractive network and the error matrix ε=|A−Â|. Here |·| denotes elementwise operation. FIG. 15B shows the all-optical transformation of different test intensity patterns by the trained diffractive network, together with the corresponding ground truths.

FIGS. 16A-16B illustrate the approximation of an arbitrary permutation A of intensity, under spatially-incoherent illumination, by a diffractive network (K=5, N=5×58²) trained using the indirect approach. FIG. 16A illustrates the target transformation A, the all-optical intensity transformation Â performed by the diffractive network and the error matrix ε=|A−Â|. Here |·| denotes elementwise operation. FIG. 16B shows the all-optical linear intensity transformation of test patterns i (performed by the diffractive network) compared against the ground truth for various structured intensity patterns such as the letters U, C, L, and A, as well as closely separated line pairs and points.

FIGS. 17A-17C illustrates the all-optical implementation of the same linear intensity transformation at discrete wavelengths by a diffractive network under spatially incoherent illumination. FIG. 17A shows the spatially incoherent diffractive network simultaneously performs the same intensity linear transformation A at N_{w}=3 discrete wavelengths λ₁, λ₂, λ₃. FIG. 17B shows an arbitrarily chosen target permutation matrix A, together with the all-optical intensity linear transformations (Â_{λ}) performed by the trained spatially incoherent diffractive network (K=5, N=5×100²≈2.035× 2N_{w}NᵢNₒ) at the three designated wavelengths and the corresponding error matrices ε_{λ}=|A−Â_{λ}|. Here |·| denotes elementwise operation. FIG. 17C illustrates the average of the elements of the error matrix ε_{λ}, as a function of the spatially incoherent illumination wavelength λ.

FIG. 18 illustrates the all-optical transformation of test intensity patterns by the trained spatially incoherent diffractive network of FIGS. 17A, at the three designated wavelengths, together with the corresponding ground truths.

FIGS. 19A-19C: All-optical implementation of multiple unique linear intensity transformations at discrete wavelengths, i.e., wavelength-multiplexing of linear intensity transformations by a diffractive network under spatially incoherent illumination. FIG. 19A schematically illustrates the spatially incoherent diffractive network simultaneously performs three unique intensity linear transformations A₁, A₂, A₃ at N_{w}=3 discrete wavelengths λ₁, λ₂, λ₃, respectively. FIG. 19B illustrates the target permutation matrices A₁, A₂, A₃, together with the all-optical intensity linear transformations (Â_{λ}) performed by the trained spatially incoherent diffractive network (K=5, N=5×100²≈2.035× 2N_{w}NᵢNₒ) at the three designated wavelengths and the corresponding error matrices ε_{λ,w}=|A_{w}−Â_{λ}|. Here |·| denotes elementwise operation. FIG. 19C illustrates the average of the elements of the error matrix ε_{λ,w}, as a function of the spatially incoherent illumination wavelength λ.

FIG. 20 illustrates the all-optical transformation of test intensity patterns by the trained spatially incoherent diffractive network of FIG. 19A at the three designated wavelengths, together with the corresponding ground truths.

FIGS. 21A-21B illustrate the approximation of an arbitrary 8²×8² linear transformation (A) of intensity, under spatially incoherent illumination, by a diffractive network (K=5, N=5×58²) trained using the PSF-based data-free design approach. For this design, the size of the intensity pixels is diffraction-limited, i.e., ~λ/2. FIG. 21A shows the target transformation A, the all-optical intensity transformation Â performed by the trained diffractive network and the error matrix ε=|A−Â|. Here |·| denotes elementwise operation. FIG. 21B shows the all-optical linear transformation of different test intensity patterns by the trained diffractive network, together with the patterns resulting from the numerical inverse mapping of the all-optical outputs through multiplication by A⁻¹. The all-optical output intensities are simulated using N_{φ,te}=100,000.

FIG. 22A schematically illustrates a K=5 phase-only diffractive network trained to perform all-optical classification of handwritten digits under spatially incoherent illumination.

FIG. 22B illustrates a confusion matrix generated by blind testing of the resulting diffractive network on 10,000 MNIST test images, evaluated using N_{φ,te}=20,000. The overall blind testing accuracy of the network on the MNIST test set was 95.04%. For the phase profiles of the trained diffractive network layers, see FIG. 25.

FIG. 23 illustrates the diffractive layer phase profiles for different designs with approximately the same number N of diffractive features distributed over K diffractive surfaces, for different K values.

FIGS. 24A and 24B illustrates the approximation of a non-square intensity linear transformation with a diffractive optical network under spatially incoherent illumination, trained using the indirect design approach. FIG. 24A illustrates the irregular distributions of Nᵢ=64 and Nₒ=49 pixels on the input and the output FOVs, respectively; color encodes the indices of the input/output pixels. FIG. 24B illustrates the target transformation A, the all-optical intensity transformation Â performed by the trained diffractive network and the error matrix ε=|A−Â| are shown. Here |·| denotes elementwise operation.

FIG. 25 illustrates the diffractive layer phase profiles for the spatially incoherent diffractive network classifier reported in FIGS. 22A-22B.

FIGS. 26A and 26B illustrate the approximation of an arbitrary 16²×16² linear transformation (A) of intensity, under spatially incoherent illumination, by a diffractive network (K=16, N=16×128²) trained using the PSF-based data-free design approach. For this design, the size of the intensity pixels is diffraction-limited, i.e., ~λ/2. FIG. 26A illustrates the target transformation A, the all-optical intensity transformation Â performed by the trained diffractive network and the error matrix ε=|A−Â|. Here |·| denotes elementwise operation. FIG. 26B illustrates the all-optical linear transformation of different test intensity patterns by the trained diffractive network, together with the patterns resulting from the numerical inverse mapping of the all-optical outputs through multiplication by A⁻¹. The all-optical output intensities are simulated using N_{φ,te}=640,000.

FIG. 27A illustrates schematically the operation of complex-valued universal linear transformations using a spatially incoherent diffractive optical network or processor.

FIG. 27B illustrates amplitude and phase of the target complex-valued linear transformation.

FIG. 27C illustrates mosaicing and demosaicing processes.

FIG. 27D illustrates image encryption method where complex-valued images are digitally encrypted (A⁻¹), and subsequently decrypted using the diffractive system that performs A (diffractive key).

FIG. 27E illustrates image encryption method where the encryption is performed through the spatially incoherent diffractive network (diffractive lock) and the decryption is performed digitally (digital key).

FIGS. 28A-28D illustrate the performance of spatially incoherent diffractive networks on arbitrary complex-valued linear transformations. FIG. 28A illustrates the all-optical linear transformation error as a function of the number of diffractive features (N). The dot (2.00—far right) represents the design corresponding to the results shown in 28B-28D. FIG. 28B illustrates the phase profiles of the K=4 diffractive layers of the optimized model (N=2×2N_{i,r}N_{o,r}). FIG. 28C illustrates the evaluation of the resulting all-optical intensity transformation, i.e., the spatially varying PSFs. FIG. 28D illustrates the complex linear transformation evaluation. For εᵣ and ε, |·|² represents an elementwise operation.

FIGS. 29A-29B illustrates image encryption with the letters ‘U’ and ‘C’ encoded into amplitude and phase, respectively, of the complex-valued image. FIG. 29A shows the input, target, output, and the approximation error, both in complex and real non-negative (intensity) domains. The original information is represented by o while i is obtained by digital encrypting o following FIG. 27D. FIG. 29B shows the input, output (resulting from optical encryption) and digitally decrypted output and the error between the input and the decrypted output. The result of digital decryption matches the input information. The second row shows the corresponding input, target and output intensities and the approximation error. |·|² represents an elementwise operation.

FIGS. 30A-30B illustrates image encryption with the letters ‘L’ and ‘A’ encoded into amplitude and phase, respectively, of the complex-valued image similar to FIGS. 29A-29B.

FIG. 31 illustrates complex-valued image decryption performance of spatially incoherent diffractive optical networks or processors as a function of the number of trainable diffractive features/neurons available.

FIGS. 32A and 32B illustrate the evaluation of the spatially incoherent diffractive optical network or processor-based complex-valued image encryption method using entropy.

FIGS. 33A and 33B illustrate the operation of a spatially incoherent diffractive optical network or processor for an arbitrarily selected mosaicing and demosaicing scheme.

FIGS. 34A and 34B illustrate the comparison between E=4 and E=3 mosaicing schemes for a spatially incoherent diffractive optical network or processor.

### DETAILED DESCRIPTION OF ILLUSTRATED EMBODIMENTS

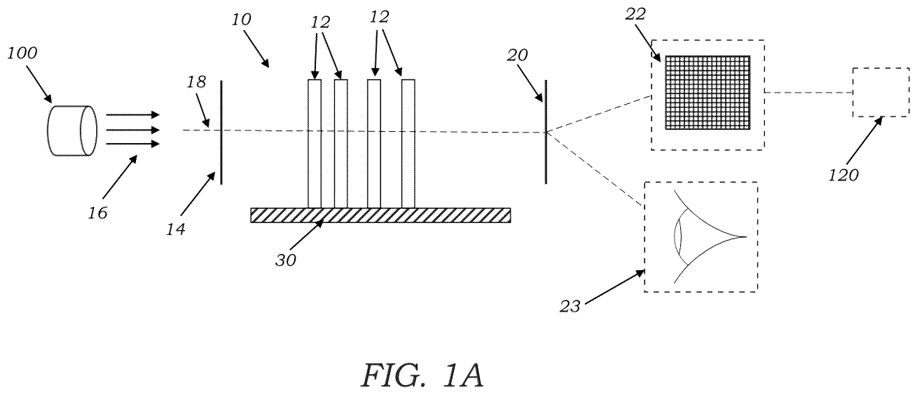

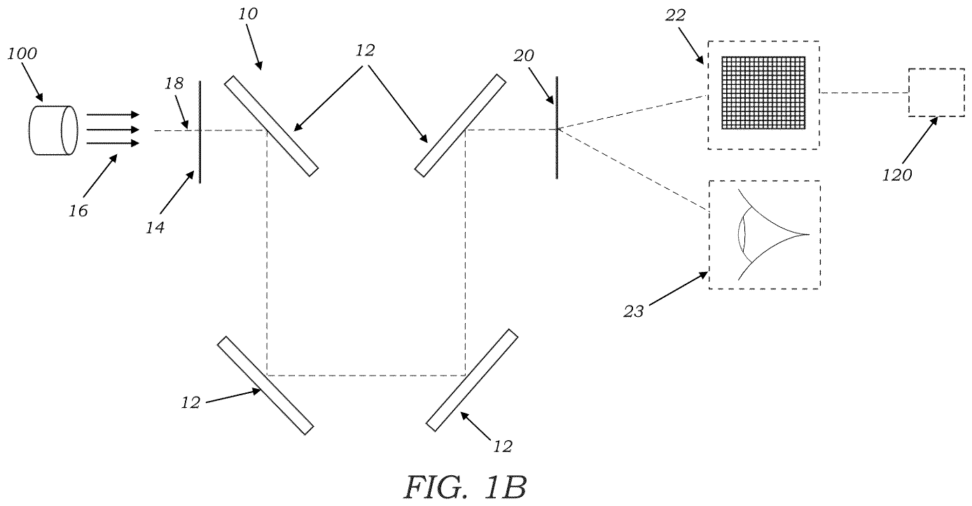

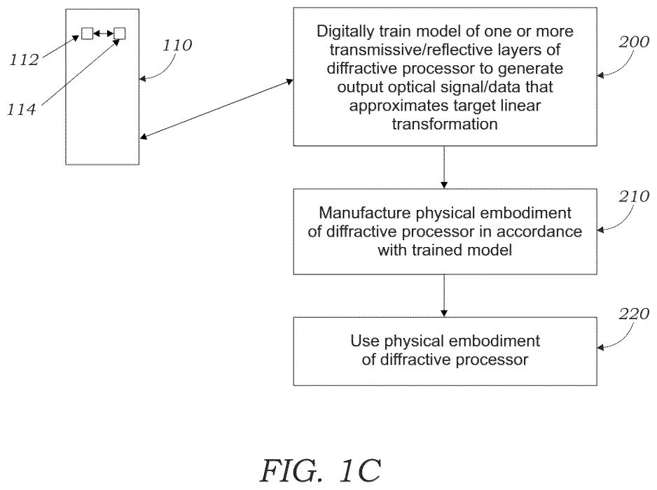

With reference to FIGS. 1A, 1B, 6A, 17A, 19A, 22A, and 27A the diffractive optical network or processor 10 contains a plurality of diffractive or substrate layers 12 that are physical layers which may be formed as a physical substrate or matrix of optically transmissive material (for transmission mode-FIG. 1A) or optically reflective material (for reflective mode—FIG. 1B). In transmission mode, light or electromagnetic radiation that includes spatially and/or temporally-incoherent light 16 passes through the substrate layers 12 as seen in FIG. 1A. Conversely, in reflective mode (FIG. 1B), light or electromagnetic radiation that includes spatially and/or temporally-incoherent light 16 reflects off the substrate layer(s) 12. Exemplary materials that may be used for the substrate layers 12 include polymers and plastics (e.g., those used in additive manufacturing techniques such as 3D printing) as well as semiconductor-based materials (e.g., silicon and oxides thereof, gallium arsenide and oxides thereof), crystalline materials or amorphous materials such as glass and combinations of the same. Metal coated materials may be used for reflective substrate layers 12.

The input optical signal or data 14 located at an input FOV to the diffractive optical network or processor 10 includes spatially and/or temporally-incoherent light 16. The spatially and/or temporally-incoherent light 16 may include one or more wavelengths or a spectral band of interest. The input optical signal or data 14 may include an optical field(s) or optical image(s). For example, in one embodiment, the input optical signal or data 14 may include spatially and/or temporally-incoherent light 16 from an object 100 as seen in FIGS. 1A and 1B. The spatially and/or temporally-incoherent light 16 may pass through the object 100 or reflect off the object 100. The spatially and/or temporally-incoherent light 16 may include natural light such as sunlight. The spatially and/or temporally-incoherent light 16 may include other parts of the electromagnetic spectrum including, for example, x-rays, visible light, infrared light, terahertz or longer wavelengths of the electromagnetic spectrum. The spatially and/or temporally-incoherent light 16 may also include artificial light. The input optical signal or data 14 may, in some embodiments, also be projected onto/into the diffractive optical network or processor 10.

The input optical signal(s) or data 14 travels along an optical path 18 as seen in FIGS. 1A and 1B. The input optical signal(s) or data 14 may be contained withing a particular field-of-view (FOV). The spatially and/or temporally-incoherent light 16 then travels along the optical path 18 that contains one or more optically transmissive and/or reflective substrate layer(s) 12 arranged in the optical path 18. An output optical signal (or output optical signals) or data 20 is generated that defines an output FOV. The output optical signal(s) or data 20 generated at the output FOV, in some embodiments, approximate the target linear transformation that the diffractive optical network or processor 10 was trained for. The diffractive optical network or processor 10 can perform any arbitrary linear transformation of time-averaged intensities between its input and the output FOVs. In one embodiment, the output optical signal or data 16 is captured by one or more image sensors or optoelectronic detectors 22 located at the output FOV as seen in FIGS. 1A and 1B. The image sensor or optoelectronic detector 22 may include, for example, a CMOS image sensor or image chip such as CCD, although the image sensor(s) or optoelectronic detectors 22 may also include photodetectors (e.g., photodiode such as avalanche photodiode detector (APD), photomultiplier (PMT) device, detector array(s), and the like. The output optical signal or data 20 that is captured with the one or more image sensors or optoelectronic detectors 22 has undergone a plurality of distinct optical transformations as compared to the input optical signal or data 14. The substrate layer(s) 12 perform or approximate the plurality of distinct optical transformations to approximate the target linear transformation that the diffractive optical network or processor 10 was trained for. In some embodiments, multiple target linear transformations are performed by the diffractive optical network or processor 10. For example, the input optical signal or data 14 may include multiple wavelengths of spatially and/or temporally-incoherent light 16 that are subject to different linear transformations simultaneously using the same diffractive optical network or processor 10.

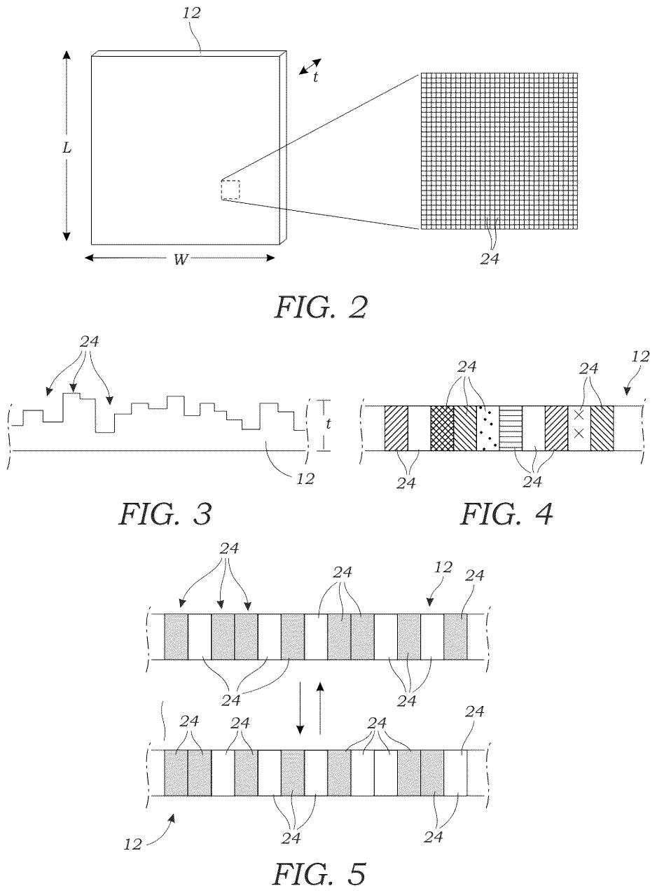

With reference to FIGS. 2-5, each diffractive or substrate layer 12 of the diffractive optical network or processor 10 has a plurality of physical features 24 formed on the surface of the diffractive/substrate layer 12 or within the diffractive/substrate layer 12 itself that collectively define a pattern of physical locations along the length and width of each substrate layer 12 that have varied transmission properties (or varied reflection properties). The physical features 24 formed on or in the substrate layers 12 thus create a pattern of physical locations on or within the substrate layers 12 that have different valued transmission properties as a function of lateral coordinates (e.g., length and width and in some embodiments depth) across each substrate layer 12 (or reflective properties for the reflective mode operation). In some embodiments, each separate physical feature 24 may define a discrete physical location on the substrate layer 12 while in other embodiments, multiple physical features 24 may combine or collectively define a physical region with a particular transmission (or reflection) property. The one or more substrate layers 12 are arranged along the optical path 18 and collectively operate on the input optical signal or data 14 to approximate the linear transformation of the target in the output optical signal or data 20. The linear transformation performed by the diffractive optical network or processor 10 is, in one embodiment, a transformation of optical intensity. In some embodiments, the linear transformation performed by the diffractive optical network or processor 10 includes encryption and/or decryption of the input optical signal or data 14.

The pattern formed by the physical features 24 on or within the diffractive/substrate layer 12 may define, in some embodiments, an array located across the surface of the substrate layer 12. With reference to FIG. 2, the substrate layer 12 in one embodiment is a two-dimensional generally planer substrate having a length (L), width (W), and thickness (t) that all may vary depending on the particular application. In other embodiments, the substrate layer 12 may be non-planer such as, for example, curved. In addition, while FIG. 2 illustrates a rectangular or square-shaped substrate layer 12 different geometries are contemplated. The physical features 24 and the physical regions formed thereby act as artificial “neurons” that connect to other “neurons” of other substrate layers 12 of the diffractive optical network or processor 10 through optical diffraction (and/or reflection) and alter the phase and/or amplitude of the light wave. The particular number and density of the physical features 24 or artificial neurons that are formed in each substrate layer 12 may vary depending on the type of application. In some embodiments, the total number of artificial neurons may only need to be in the hundreds or thousands while in other embodiments, hundreds of thousands or millions of neurons or more may be used. Likewise, the number of substrate layers 12 that are used in a particular diffractive optical network or processor 10 may vary although it typically ranges from at least two (2) substrate layer 12 to less than ten (10) substrate layers 12. In some embodiments, a single (1) substrate layer 12 may suffice.

After a last substrate layer 12 in the optical path 18, in one embodiment, one or more image sensors or optoelectronic detectors 22 is/are provided that captures the output optical signal or data 20. In another embodiment, the output optical signal or data 20 may be projected on a surface or volume 23. The surface or volume 23 may include a projection surface/volume on which an image is displayed. The surface or volume 23 may also include the surface or volume of the eye such as illustrated in FIGS. 1A and 1B. The surface or volume 23 may also include a display or goggle.

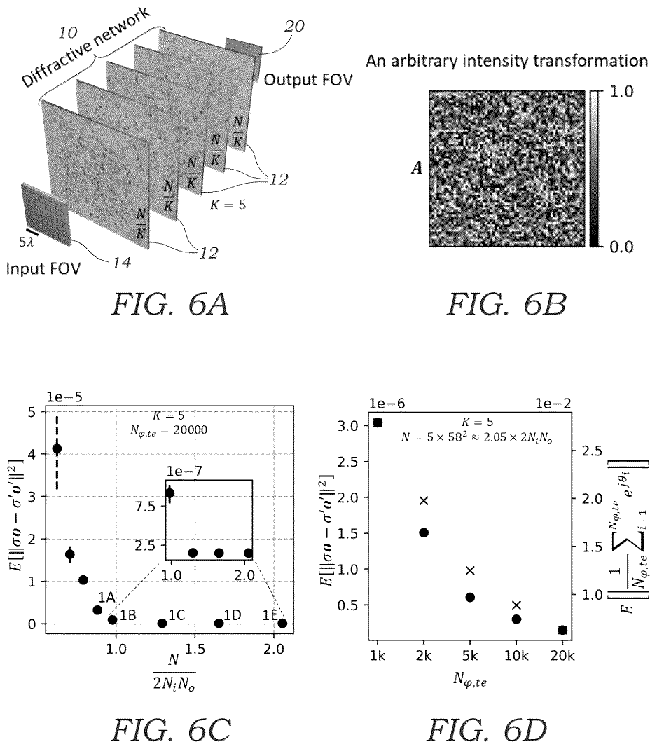

FIG. 3 illustrates one embodiment of how different physical features 24 are formed in the substrate layer 12. In this embodiment, a substrate layer 12 has different thicknesses (t) of material at different lateral locations along the substrate layer 12. In one embodiment, the different thicknesses (t) modulate the phase of the light passing through the substrate layer 12. This type of physical feature 24 may be used, for instance, in the transmission mode embodiment of FIGS. 1A and 6A. The different thicknesses of material in the substrate layer 12 forms a plurality of discrete “peaks” and “valleys” that control the transmission properties of the neurons formed in the substrate layer 12. The different thicknesses of the substrate layer 12 may be formed using additive manufacturing techniques (e.g., 3D printing) or lithographic methods utilized in semiconductor processing. For example, the design of the substrate layers 12 may be stored in a stereolithographic file format (e.g., .stl file format) which is then used to 3D print the substrate layers 12. Other manufacturing techniques include well-known wet and dry etching processes that can form very small lithographic features on a substrate layer 12. Lithographic methods may be used to form very small and dense physical features 24 on the substrate layer 12 which may be used with shorter wavelengths of the light. As seen in FIG. 3, in this embodiment, the physical features 24 are fixed in permanent state (i.e., the surface profile is established and remains the same once complete).

FIG. 4 illustrates another embodiment in which the physical features 24 are created or formed within the substrate layer 12. In this embodiment, the substrate layer 12 may have a substantially uniform thickness but have different regions of the substrate layer 12 have different optical properties. For example, the refractive (or reflective) index of the substrate layers 12 may altered by doping the substrate layers 12 with a dopant (e.g., ions or the like) to form the regions of neurons in the substrate layers 12 with controlled transmission and/or reflection properties (or absorption and/or spectral features). In still other embodiments, optical nonlinearity can be incorporated into the network design using various optical non-linear materials (e.g., crystals, polymers, semiconductor materials, doped glasses, polymers, organic materials, semiconductors, graphene, quantum dots, carbon nanotubes, and the like) that are incorporated into the substrate layer 12. A masking layer or coating that partially transmits or partially blocks light in different lateral locations on the substrate layer 12 may also be used to form the neurons on the substrate layers 12.

Alternatively, the transmission function of the physical features 24 or neurons can also be engineered by using metamaterial or plasmonic structures. Combinations of all these techniques may also be used. In other embodiments, non-passive components may be incorporated into the substrate layers 12 such as spatial light modulators (SLMs). SLMs are devices that imposes spatial varying modulation of the phase, amplitude, or polarization of a light. SLMs may include optically addressed SLMs and electrically addressed SLM. Electric SLMs include liquid crystal-based technologies that are switched by using thin-film transistors (for transmission applications) or silicon backplanes (for reflective applications). Another example of an electric SLM includes magneto-optic devices that use pixelated crystals of aluminum garnet switched by an array of magnetic coils using the magneto-optical effect. Additional electronic SLMs include devices that use nanofabricated deformable or moveable mirrors that are electrostatically controlled to selectively deflect light.

FIG. 5 schematically illustrates a cross-sectional view of a single substrate layer 12 of a diffractive optical network or processor 10 according to another embodiment. In this embodiment, the substrate layer 12 is reconfigurable in that the optical properties of the various physical features 24 that form the artificial neurons may be changed, for example, by application of a stimulus (e.g., electrical current or field). An example includes spatial light modulators (SLMs) discussed above which can change their optical properties. In other embodiments, the layers may use the DC electro-optic effect to introduce optical nonlinearity into the substrate layers 12 of the diffractive optical network or processor 10 and require a DC electric-field for each substrate layer 12 of the optical network or processor 10. This electric-field (or electric current) can be externally applied to each substrate layer 12 of the diffractive optical network or processor 10. Alternatively, one can also use poled materials with very strong built-in electric fields as part of the material (e.g., poled crystals or glasses). In this embodiment, the neuronal structure is not fixed and can be dynamically changed or tuned as appropriate (i.e., changed on demand). This embodiment, for example, can provide a learning diffractive optical network or processor 10 or a changeable diffractive optical network or processor 10 that can be altered on-the-fly to improve the performance, compensate for aberrations, or even change another task.

As explained herein, and with reference to FIG. 1C, a computerized or digital model of the diffractive optical network or processor 10 is first digitally trained with machine learning (e.g., deep learning) using a computing device 120 having one or more processors 112. As seen in operation 200, at least one computing device 120 having one or more processors 112 executes software 114 thereon to digitally train a model or mathematical representation of the diffractive optical network or processor 10. During this training phase, a set of input/output intensity patterns are used to define or optimize the plurality of physical features 24 formed on or within the one or more optically transmissive and/or reflective substrate layer(s) 12 to perform the complex-valued linear transformation between the input and output FOVs. Specifically, the training defines or optimizes the plurality of physical features 24 formed on or within the one or more optically transmissive or reflective substrate layer(s) 12 to generate the output optical signal(s) or data 20 that approximate the target linear transformation of the input optical signal or data 14. This may be done indirectly by using spatially coherent illumination 16 to perform the complex-valued linear transformation between input and output FOVs. Alternatively, this may be done directly by simulating the output intensity of the diffractive processor 10 through the incoherent propagation of the input intensity patterns.

Once the design or model has been established that encodes a physical layout for the different physical features 24 that form the artificial neurons in each of the plurality of substrate layers 20 which are present in the optical network or processor 10, the actual physical embodiment of the optical network or processor 10 is then manufactured or fabricated that reflects the computer-derived design. This is illustrated in operation 210 of FIG. 1C. The design, in some embodiments, may be embodied in a software format (e.g., SolidWorks, AutoCAD, Inventor, or other computer-aided design (CAD) program or lithographic software program) may then be manufactured into a physical embodiment that includes the substrate layers 20. The substrate layers 20, once manufactured may be mounted or disposed in a holder or housing 30 as explained herein (e.g., illustrated in FIG. 1A). The holder or housing 30 may include a number of slots formed therein to hold the substrate layers 20 in the required sequence along the optical path 18 and with the required spacing between adjacent substrate layers 20 (if needed). The components held in the holder 30 may be removable. The physical substrate layers 12 may also be integrated into a monolithic structure in other embodiments. The substrate layers 12 may also be incorporated into a waveguide like an optical fiber.

Once the physical embodiment of the optical network or processor 10 has been made, the optical network or processor 10 is then used to perform any arbitrary complex-valued linear transformation between its input and output fields-of-view (FOVs) of the spatially and/or temporally-incoherent light 16. Use of the physical embodiment is seen in operation 220 in FIG. 1C.

In one embodiment, the training phase includes digitally training a deep neural network model of the diffractive optical network or processor 10 to directly approximate the target linear transformation with a plurality of training input optical signals/data contained in spatially-incoherent light and/or temporally-incoherent light. In another embodiment, this is done indirectly as explained herein.

It should be appreciated that while transmission mode embodiments (FIG. 1A) and reflection mode embodiments (FIG. 1B) are contemplated, other embodiments may include aspects of each. A single diffractive optical network processor 10 may include substrate layer(s) 12 that transmit spatially-incoherent light and/or temporally-incoherent light as well as substrate layer(s) 12 that reflect spatially-incoherent light and/or temporally-incoherent light. The diffractive optical network or processor 10 described herein may be integrated into one or devices. For example, the diffractive optical network or processor 10 may disposed on the optical path of a microscope, imaging system, camera, telescope, sensor, or endoscope.

### Results

### Theoretical Analysis

Spatially-coherent monochromatic diffractive optical networks can be characterized by a 4-dimensional complex-valued coherent impulse response function (i.e., the point spread function) that is spatially-varying, connecting the input and output FOVs: h(x, y; x′, y′). Stated differently, each arbitrarily-selected complex-valued linear transformation that is desired between the pixels of an input FOV and output FOV results in a spatially-varying impulse response function h(x, y; x′, y′), where (x′, y′) and (x, y) define the input and output FOVs, respectively. Based on this definition, the complex-valued output field o_{c}(x, y) of a spatially-coherent diffractive processor is related to the complex-valued input field i_{c} (x′, y′) by:

$${o}_{c} ( x , y ) = \int \int {h}_{c} ( x , y ; {x}^{′} , {y}^{′} ) {i}_{c} ( {x}^{′} , {y}^{′} ) {dx}^{′} {dy}^{′} \qquad ( 1 )$$

The subscript c indicates that the quantities are functions of continuous spatial variables x, y, x′, y′, representing the transverse coordinates on the output and input planes. If these optical fields are sampled at an interval (δ) sufficiently small to preserve the spatial variations, satisfying the Nyquist criterion, one can write:

$$o ( m , n ) = {\sum }_{{m}^{′} , {n}^{′}} h ( m , n ; {m}^{′} , {n}^{′} ) i ( {m}^{′} , {n}^{′} ) \qquad ( 2 )$$

Here, m, n, m′, n′ refer to discrete indices such that o(m, n)=o_{c} (mδ, nδ) and i(m′,n′)=i_{c}(m′δ, n′δ). The instantaneous output intensity can be written as:

$${\vert o ( m , n ) \vert}^{2} = {\sum }_{{m}^{′} , {n}^{′} , {m}^{″} , {n}^{″}} h ( m , n ; {m}^{′} , {n}^{′} ) {h}^{*} ( m , n ; {m}^{″} , {n}^{″} ) \vert i ( {m}^{′} , {n}^{′} ) \vert \vert i ( {m}^{″} , {n}^{″} ) \vert {e}^{j ( φ ( {m}^{′} , {n}^{′} ) - φ ( {m}^{″} , {n}^{″} ) )} \qquad ( 3 )$$

where φ(·) is the phase function of the input field i, i.e., i=|i|e^{jφ}, and h* denotes the complex conjugate of h. The time-averaged output intensity can be written as:

$$O ( m , n ) = 〈 {\vert o ( m , n ) \vert}^{2} 〉 = {\sum }_{{m}^{′} , {n}^{′} , {m}^{″} , {n}^{″}} h ( m , n ; {m}^{′} , {n}^{′} ) {h}^{*} ( m , n ; {m}^{″} , {n}^{″} ) \vert i ( {m}^{′} , {n}^{′} ) \vert \vert i ( {m}^{″} , {n}^{″} ) \vert 〈 {e}^{j Δφ} 〉 \qquad ( 4 )$$

where [symbol] · [symbol] denotes time-average operation and Δφ=φ(m′,n′)−φ(m″, n″). Since the illumination light is spatially-incoherent, the phases at different spatial points of the input vary randomly over time and are independent of each other. Stated differently for stationary objects/scenes that are uniformly illuminated with a spatially-incoherent light, Δφ varies randomly between 0 and 2π over time, yielding [symbol] e^{jΔφ} [symbol] =0 for (m′, n′)≠(m″, n″). As a result of this, under spatially-incoherent illumination, Eq. (4) can be written as:

$$O ( m , n ) = {\sum }_{{m}^{′} , {n}^{′}} {\vert h ( m , n ; {m}^{′} , {n}^{′} ) \vert}^{2} 〈 {\vert i ( {m}^{′} , {n}^{′} ) \vert}^{2} 〉 = {\sum }_{{m}^{′} , {n}^{′}} H ( m , n ; {m}^{′} , {n}^{′} ) I ( {m}^{′} , {n}^{′} ) \qquad ( 5 )$$

where I= [symbol] |i|² [symbol] is the time-averaged input intensity and H(m, n; m′, n′)=|h(m, n; m′, n′)|² is the intensity impulse response of the diffractive optical processor 10 under spatially-incoherent illumination. From now on, unless otherwise stated, the term optical ‘intensity’ is used to imply time-averaged intensity functions. Similarly, whenever all-optical linear transformation of intensity is mentioned, spatially-incoherent monochromatic illumination is implied unless stated otherwise.

It should be emphasized that while H(m, n; m′, n′)=|h(m, n; m′, n′)|², one has in general O(m, n)≠|o(m, n)|². Therefore, the output intensity of a spatially-incoherent diffractive network or processor 10 cannot be calculated as |o(m, n)|²=|Σ_{m′n′}h(m, n; m′, n′) i(m′, n′)|². For the numerical forward model corresponding to each input object, as will be detailed in the next section, a large number of random phase distributions were used at the input plane to approximate O(m, n)= [symbol] |o(m, n)|² [symbol] under spatially-incoherent illumination.

### Numerical Analysis

In this subsection, the design of diffractive optical processors 10 to perform an arbitrary linear intensity transformation between the input FOV 14 and the output FOV 20 under spatially-incoherent illumination 16 is numerically explored. It is assumed, as shown in FIG. 6A, N independent diffractive features 24 (phase-only elements) that are distributed over K diffractive surfaces 12, each with N/K diffractive features, between the input and output planes. Following from Eq. (5), if one rearranges the pixel intensities of I(m′, n′) and O(m, n) as column vectors i and o, then one can write o=A′i, where A′ represents the linear intensity transformation performed by the diffractive optical network 10 under spatially-incoherent illumination 16. The elements of A′ correspond to the elements of the intensity impulse response H(m, n; m′, n′); see Eq. (5). Note that all the elements of A′ are real and nonnegative since it represents a linear intensity transformation with H(m, n; m′, n′)=|h(m, n; m′, n′)|². Hence, in the context of arbitrary linear transformations in intensity, only real transformation matrices with nonnegative elements are considered.

For the target linear transformation that is to be approximated by the spatially-incoherent diffractive processor 10, initially, an arbitrary matrix A, was selected as shown in FIG. 6B. In the following numerical analysis, N diffractive features 24 are optimized of a phase-only diffractive processor so that A′≈A under spatially-incoherent illumination. The size of A is chosen as Nₒ×Nᵢ=64×64, i.e., the number of pixels at both the input (Nᵢ) and the output (Nₒ) FOVs are 8×8, arranged in a square grid. Each element of the matrix A is randomly sampled from a uniform probability distribution between 0 and 1, i.e., A[p, q]~Uniform(0, 1) where A[p, q] is the element at p-th row and q-th column of A, p=1, . . . , Nₒ and q=1, . . . , Nᵢ.

For the deep learning-based optimization of the design of a phase-only diffractive network or processor 10 to achieve A′≈A, two different data-driven supervised learning approaches were followed: (1) the indirect approach and (2) the direct approach. In the indirect approach, instead of directly training the diffractive network 10 to perform the linear intensity transformation A, the network 10 was trained, under spatially-coherent illumination 16, to perform the complex-valued linear transformation A̅ between the input and output FOVs 14, 20 such that |A̅[p, q]=\sqrt{A[p, q]}, which would result in an intensity linear transformation |A̅[p, q]|²=A[p, q] under spatially-incoherent illumination. For the purpose of the training, the phase of A̅[p, q] was defined to be zero, i.e., A̅[p, q]=\sqrt{A[p, q]}exp(j0); however, any other phase distribution could also be used since the design space is not unique. Stated differently, in this indirect approach, a diffractive network 10 was designed that can achieve a spatially-coherent impulse response h(m, n; m′, n′), which will ensure that the same design has a spatially-incoherent impulse response of H(m, n; m′, n′)=|h(m, n; m′, n′)|² such that A′≈A can be satisfied under spatially-incoherent illumination. To achieve this goal, the relationship õ=A̅ĩ was used to generate a large set of input-target complex-valued optical field pairs (ĩ, õ), and used deep learning to optimize the phase values of the diffractive features by minimizing the mean squared error (MSE) loss between the target complex field õ and the complex field õ′ obtained by coherently propagating ĩ through the diffractive network (see the Methods section). In other words, spatially-coherent design of a diffractive network is used here as a proxy for the design of a spatially-incoherent diffractive network 10 that can achieve any arbitrary intensity linear transformation between its input and output FOVs 14, 20.

In the second approach (termed the direct approach), the diffractive network 10 was trained to perform the desired intensity linear transformation A between the input and the output FOVS 14, 20, by directly using the relationship o=Ai to generate a large set of input-target intensity pairs (i, o). Using this large training set of input/output intensity patterns, the transmission phase values of the diffractive layers were optimized using deep learning, by minimizing the MSE loss between the output pixel intensities of the diffractive processor o′ and the ground-truth intensities o (see the Methods section). During the training phase, the output intensity of the diffractive processor 10 was simulated through the incoherent propagation of the input intensity patterns, i or I(m′, n′). To numerically simulate the spatially-incoherent propagation of I(m′, n′), the input optical field was assumed to be \sqrt{I}e^{jφ} where φ is a random 2D phase distribution, i.e., φ(m′, n′)~Uniform (0, 2π) for each (m′, n′). This input field with the random phase distribution φ was coherently propagated through the diffractive surfaces to the output plane, using the angular spectrum approach. This coherent wave propagation was repeated N_{φ} times for every i, each time with a different random phase φ(m′, n′) distribution, and averaged the resulting N_{φ} output intensities. As N_{φ}→∞, the average intensity would approach the theoretical time-averaged output intensity for spatially-incoherent illumination, i.e., O(m, n)= [symbol] |o(m,n)|² [symbol] . Due to the limited availability of computational resources, for the direct training (the second design approach) of the spatially-incoherent diffractive optical processors 10, N_{φ}=N_{φ,tr}=1000 were used.

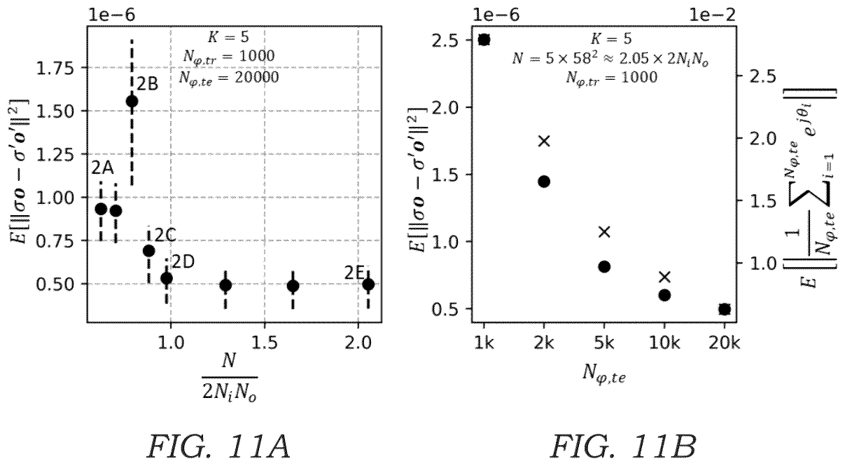

The diffractive models reported in FIGS. 6A-6D through FIGS. 10 and 15A-15B were trained using the indirect approach while the ones in FIGS. 11A-11B through FIG. 14 were trained using the direct approach. All the diffractive networks 10 reported herein, after their training using either the direct or indirect design approaches, were evaluated and blindly tested through the incoherent propagation of input intensities with N_{φ,te}=20,000. Since the testing is computationally less cumbersome compared to the training, N_{φ,te}=20,000>>N_{φ,tr} was used.

Unless otherwise stated, the size of the input and the output pixels is assumed to be ~2.13λ×2.13λ, where λ is the illumination wavelength. After the training phase, the resulting diffractive processor designs were tested using 20,000 test intensity patterns i that were never used during training; the size of this testing intensity set (20,000) should not be confused with N_{φ,te}=20,000 since for each input intensity test pattern of this set, N_{φ,te}=20,000 random 2D phase patterns were used to compute the corresponding spatially-incoherent output intensity. In FIG. 6C, the approximation errors of eight different phase-only diffractive processors trained using the indirect approach, each with K=5 diffractive layers 12, are reported as a function of N. The mean error (FIG. 6C) for each diffractive design was calculated at the output intensity patterns o′ with respect to the ground truth o=Ai, by averaging over the 20,000 test intensity patterns. FIG. 6C reveals that the approximation error of the spatially-incoherent diffractive processors 10 reaches a minimum level as

$$\frac{N}{2 {N}_{i} {N}_{o}}$$

approaches 1, and stays at the same level for N≥2NᵢNₒ.

To understand the impact of N_{φ,te} on these approximation error calculations, diffractive processor design #1E shown in FIG. 6C was taken (i.e., K=5, N≈2.1 ×2NᵢNₒ), and used different N_{φ,te} values at the blind testing phase for evaluating the average test error on the same intensity test set composed of 20,000 patterns i. As shown in FIG. 6D, the computed error values decrease as N_{φ,te} increases, as expected. On the right y-axis of the same FIG. 6D, shows, as a function of N_{φ,te}, the expectation value of

$$\vert \frac{1}{{N}_{φ , te}} {\sum }_{i = 1}^{{N}_{φ , te}} {e}^{j {θ}_{i}} \vert ,$$

where θᵢ~Uniform(0, 2π). This expectation value of the residual magnitude of

$$\frac{1}{{N}_{φ , te}} {\sum }_{i = 1}^{{N}_{φ , te}} {e}^{j {θ}_{i}}$$

decreases as N_{φ,te} increases and would approach zero as N_{φ,te}→∞. The numerically simulated output intensity of a diffractive processor design approaches the true time-averaged intensity of the spatially-incoherent wave as N_{φ,te} gets larger, following a similar trend as

$$\vert \frac{1}{{N}_{φ , te}} {\sum }_{i = 1}^{{N}_{φ , te}} {e}^{j {θ}_{i}} \vert ,$$

reported in FIG. 6D. This comparison also highlights the fact that the choice of using N_{φ,te}=20,000 random 2D phase patterns to compute the spatially-incoherent output intensity patterns in the blind testing phase is an accurate approximation.

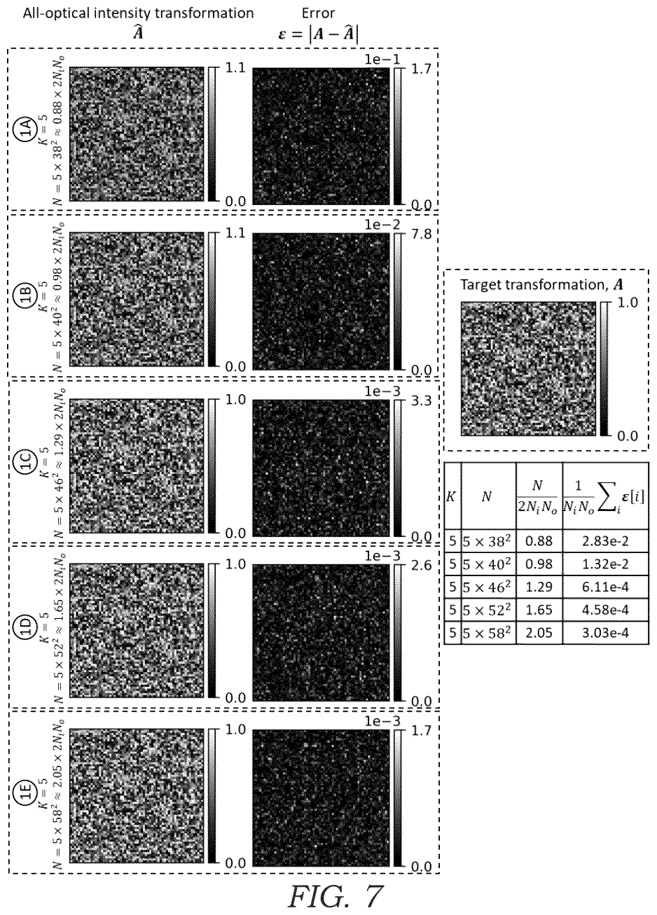

Next, FIG. 7 shows the scaled intensity linear transformations, Â, that were approximated by five of the trained diffractive networks 10 of FIG. 6C. Â is related to the physical transformation A′ by a scalar factor GA (see the ‘Evaluation’ subsection in ‘Methods’ section) which compensates for diffraction efficiency-related optical losses. The error matrix with respect to the target A, i.e., ε=|A−Â|, is shown and the average of the error matrix elements in the table are reported on the right. Here |·| denotes the elementwise operation. As N increases, the diffractive networks' resulting matrices resemble the ground truth target better and the approximation error decreases steadily; however, the improvement is more prominent as N approaches 2NᵢNₒ and stagnates beyond N≈2NᵢNₒ.

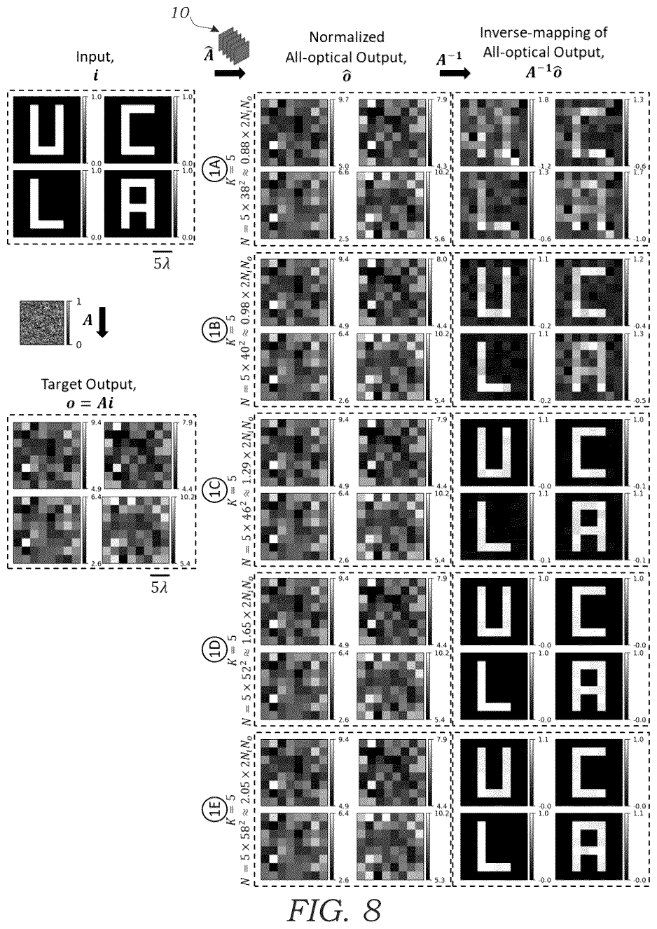

To provide visually more noticeable illustrations of the diffractive networks' all-optical intensity transformations under spatially-incoherent illumination 16, structured intensity patterns were used such as the letters U, C, L, and A as input intensity to the diffractive networks 10 (see FIG. 8). Because of the randomness of the elements of the intensity transformation matrix, the output pixel intensities also appear random (harder to compare visually against the ground truth). However, the reappearance of the letters after a numerical inversion through the multiplication of the scaled output intensity ô by the inverse of the target transformation, A⁻¹, would indicate Â≈A and validate the correctness of the diffractive networks' approximations in a visually noticeable manner (see the ‘Evaluation’ subsection of the Methods section for the definition of ô). In the case of the diffractive network 10 #1A (K=5, N=5×38²≈0.88×2NᵢNₒ), the result of such an inversion does not quite reveal any recognizable patterns, indicating the near-failure of the all-optical approximation of this design #1A. However, such inversion reveals the recognizable patterns (U, C, L, and A) as N approaches 2NᵢNₒ (design #1B) and becomes identical to the inputs as N exceeds 2NᵢNₒ (e.g., design #1C). These results show that for the K=5 phase-only diffractive networks 10 with a sufficiently large N≥~2NᵢNₒ, one has Â≈A, indicating that these networks could faithfully approximate the target intensity linear transformation under spatially-incoherent illumination.

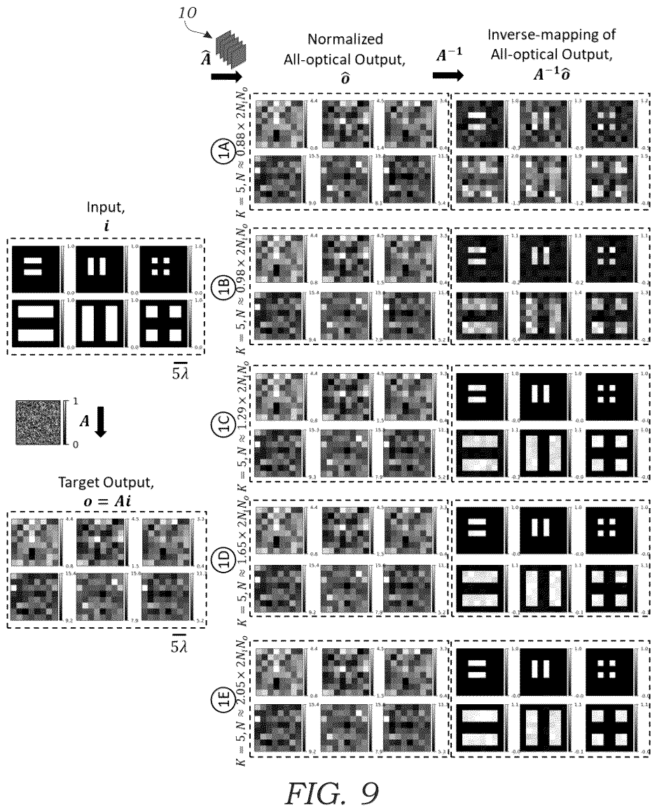

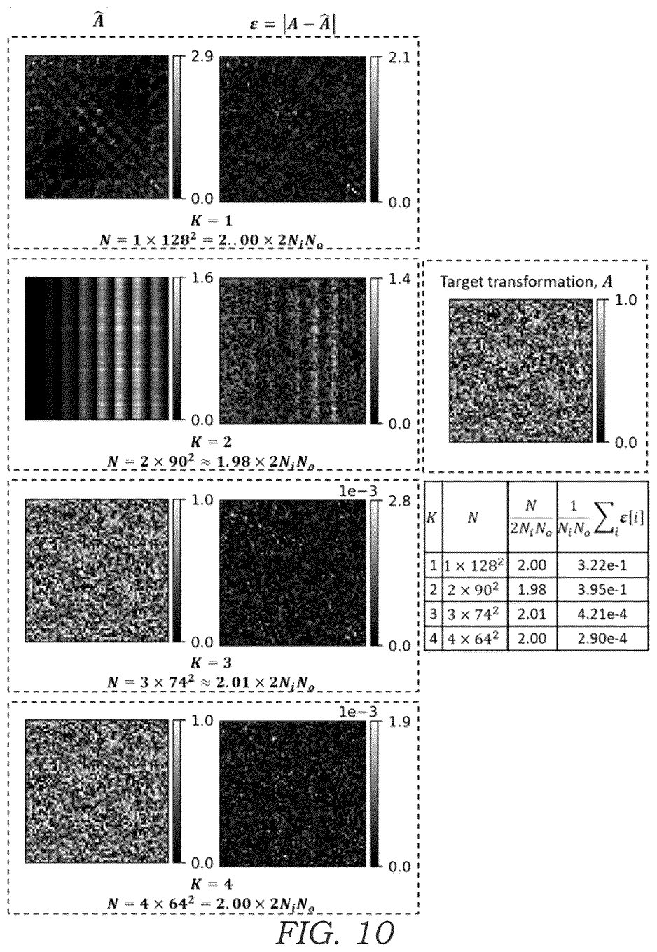

For computational imaging and sensing applications, such as in microscopy, exploring patterns of closely spaced lines and points would be interesting. Motivated by this, the same procedures outlined in FIG. 8 were repeated for various intensity patterns consisting of closely separated line pairs and sets of points, the results of which are summarized in FIG. 9. The same conclusions drawn previously in FIG. 8 hold: for N ≥~2NᵢNₒ one has Â≈A.

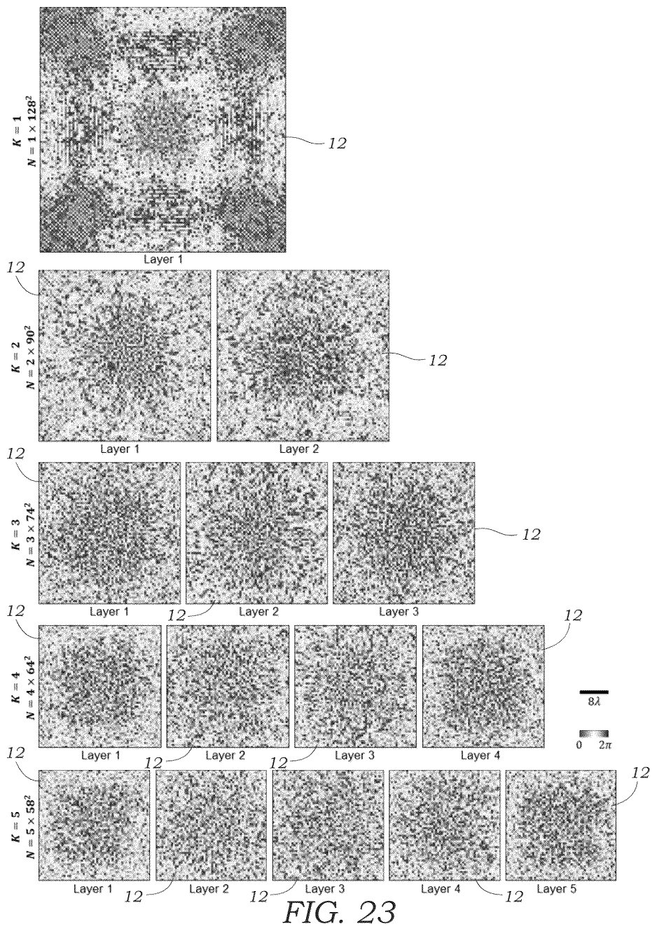

The dependence of the all-optical approximation of intensity linear transformations on the number K of diffractive layers 12 was investigated; see FIG. 10. The results of this analysis reveal that even with N≈2×2NᵢNₒ, K=1 and K=2 diffractive designs failed to approximate the target linear transformation despite having a large N, whereas the designs with K>2 successfully approximated the target transformation under spatially-incoherent illumination 16. This confirms that the depth of the diffractive network design is a key architectural factor in the computational capacity of diffractive processors 10 to perform arbitrary linear transformations. The diffractive layer phase distributions for different designs with approximately the same N≈2×2NᵢNₒ diffractive features 24 are shown in FIG. 23 for different K values. For example, the phase profile of the diffractive/substrate layer 12 for K=1 looks significantly different from the diffractive/substrate layers 12 of the other deeper diffractive networks 10.

Next, the blind testing results are reported of the diffractive processors 10 that were trained using the second design approach (i.e., direct approach), to perform the same arbitrary intensity linear transformation as has been considered so far. In FIG. 11A, the approximation errors of eight different phase-only diffractive processors 10 trained using the direct approach, each with K=5 diffractive layers 12, are reported as a function of N. The mean error was calculated over the same 20,000 test intensity patterns used in FIG. 6C; for each test intensity pattern, the incoherent output intensity o′ was calculated using N_{φ,te}=20000 (same as before). In these alternative diffractive designs, the approximation error of the diffractive processors reaches a minimum level as

$$\frac{N}{2 {N}_{i} {N}_{o}}$$

approaches 1, anu stays at the same level for N ≥2NᵢNₒ—the same conclusion reached for the indirect designs reported earlier. However, compared with the previous designs that used the indirect approach, here, the minimum error level obtained using the direct approach is approximately three times higher. This can be attributed to the use of a relatively small N_{φ,tr}=1000 during the training, and these designs can be further improved by increasing N_{φ,tr} using a longer training effort with more computational resources.

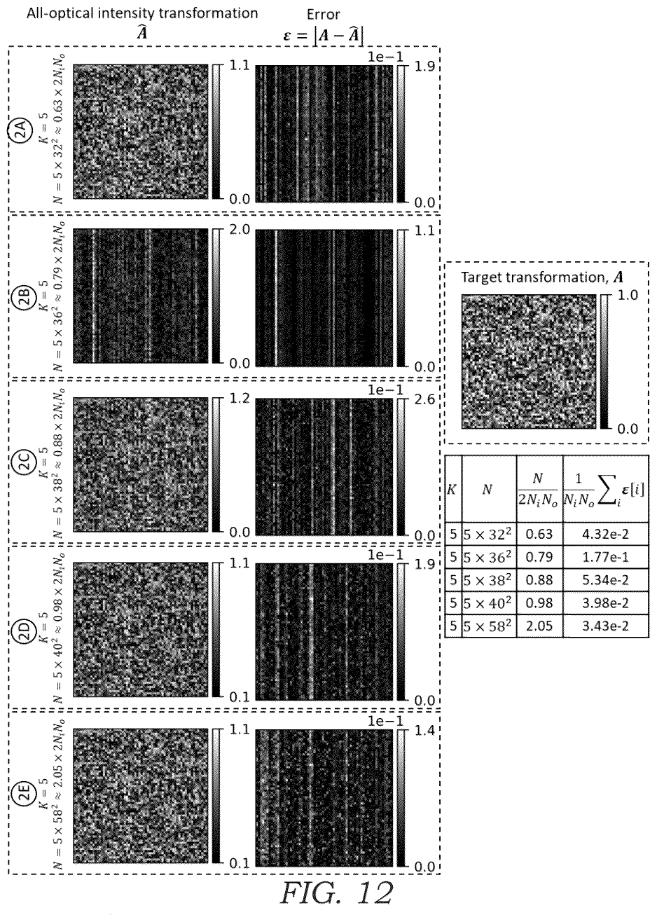

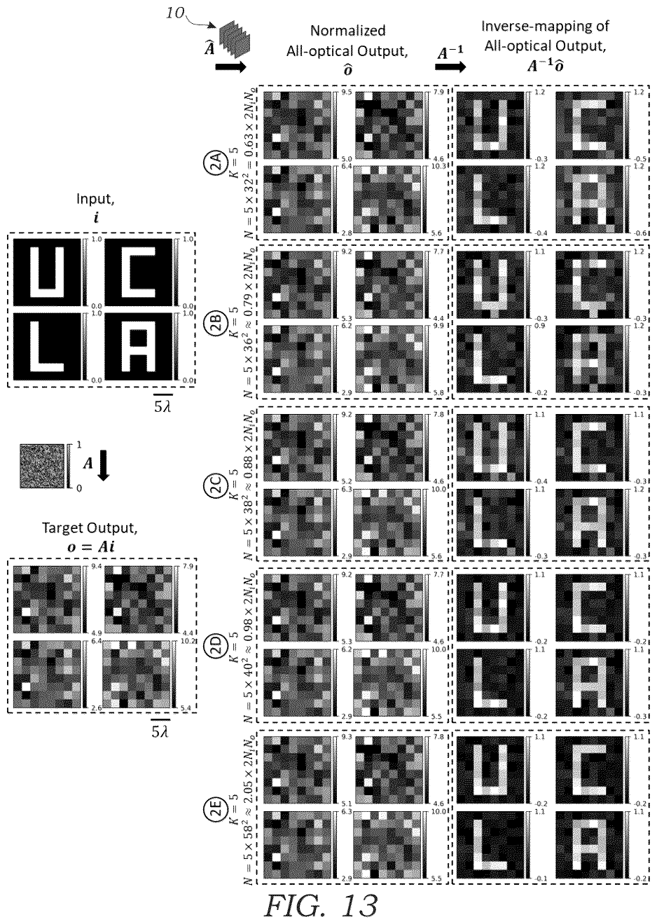

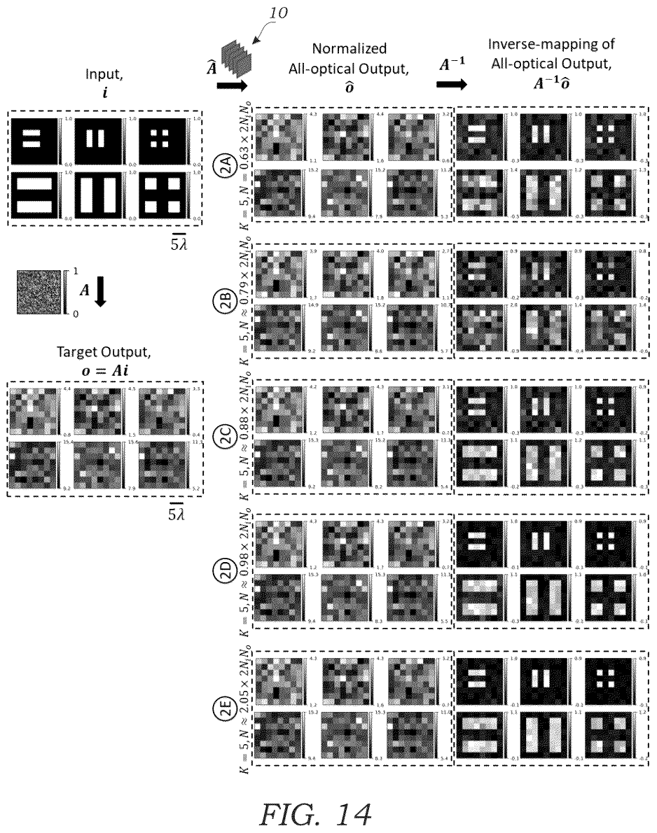

FIG. 12 shows the scaled linear intensity transformations, Â, that were approximated by five of the trained diffractive networks 10 of FIG. 11A. For each case, the error matrix is shown with respect to the target A, i.e., ε=|A−Â|, and report the average of the error matrix elements in the table on the right. As N increases, the mean intensity transformation error decreases, except for design #2B which is believed is an outlier resulting from poor convergence. The relatively large error of the design #2B is due to the diffraction efficiency imbalance among the individual input pixels, as evident from the uneven magnitudes across the columns of Â. Similarly, the other designs of the direct approach reveal uneven magnitudes across the columns of ε, indicating some diffraction efficiency imbalance among the individual input pixels, albeit not as severe as the design #2B. Despite such imperfections, these diffractive networks 10 designed using the direct approach effectively learned the target intensity transformation, as evident from FIGS. 13 and 14. FIG. 13 reveals that, for all the designs, the multiplication of the output intensity patterns ô by the inverse of the target transformation, A⁻¹ brings back the patterns U, C, L, A. Although, the reconstruction quality is better for N≈2NᵢNₒ and remains similar beyond N>2NᵢNₒ, the improvement is not as sharp as it was with the indirect approach (see FIG. 13 vs. FIG. 8 and FIG. 14 vs. FIG. 9). In contrast with the diffractive networks 10 designed using the indirect approach, here in this case, the diffractive networks 10 with N<2NᵢNₒ (e.g., design #2A) succeeded in approximating the linear transformation to the extent of revealing recognizable patterns after a numerical inverse mapping. These same observations also hold for the intensity patterns that consist of closely spaced lines and points, as shown in FIG. 14.

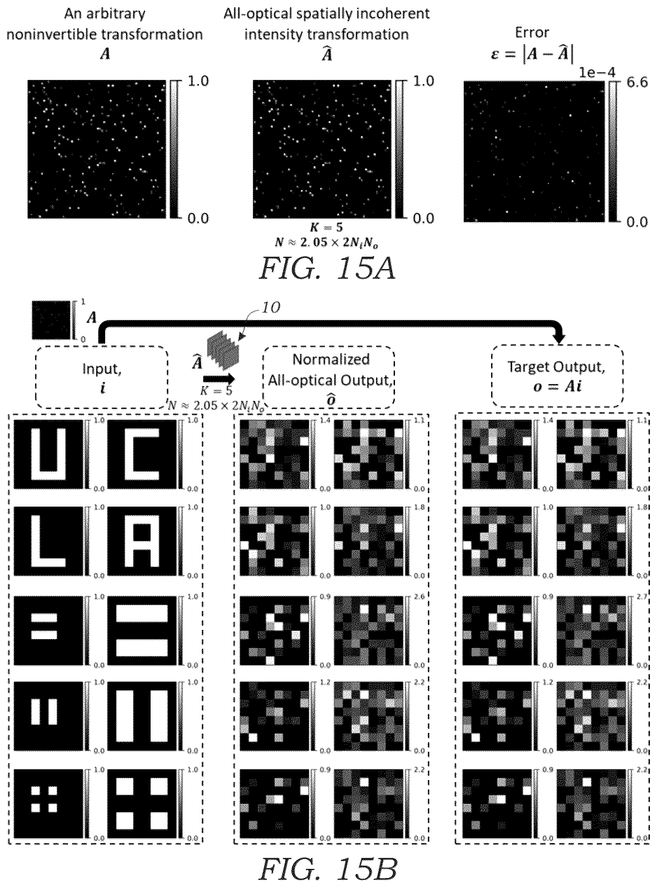

Finally, FIGS. 15A-15B reports the performance of a diffractive network 10 (K=5, N≈2×2NᵢNₒ) trained using the indirect approach to approximate another arbitrary intensity linear transformation, defined by a non-invertible matrix. The target transformation A, the approximate all-optical transformation Â, and the error matrix ε=|A−Â| are shown in FIG. 15A, revealing that the diffractive network design performed the target intensity transformation with negligible error. FIG. 15B shows the performance of this diffractive network design on test patterns (U, C, L, and A as well as line pairs and points). The all-optical outputs 20 are identical to the ground truth outputs, further confirming that Â≈A. Another example of the all-optical approximation of an arbitrary intensity transformation (defined by a random permutation matrix) is also reported in FIGS. 16A-16B.

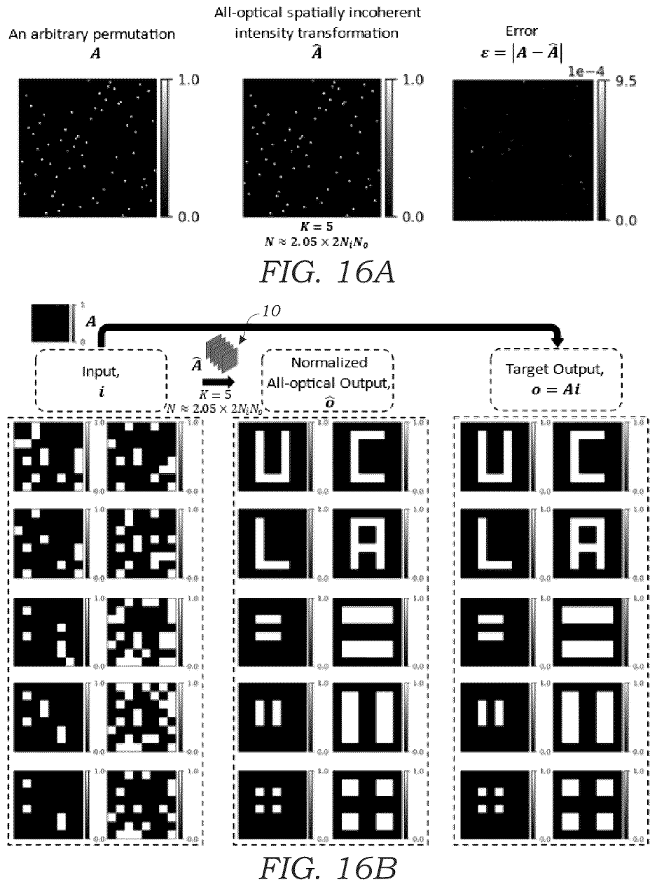

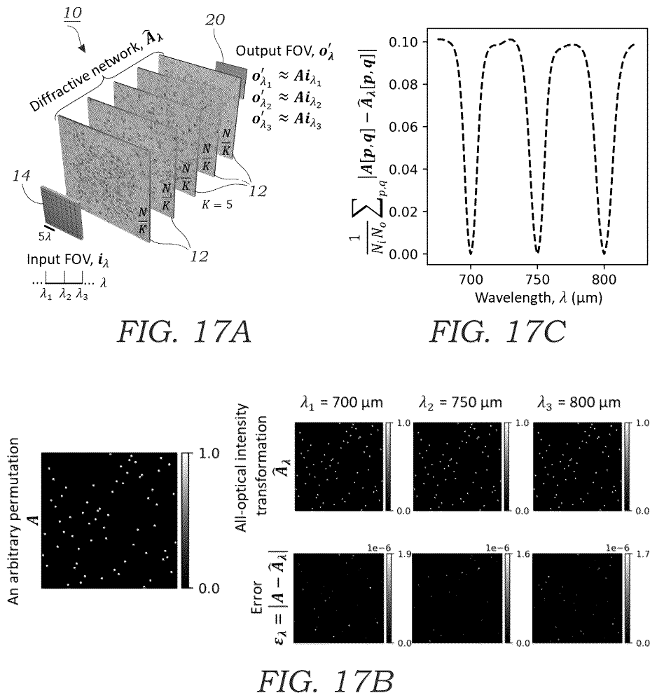

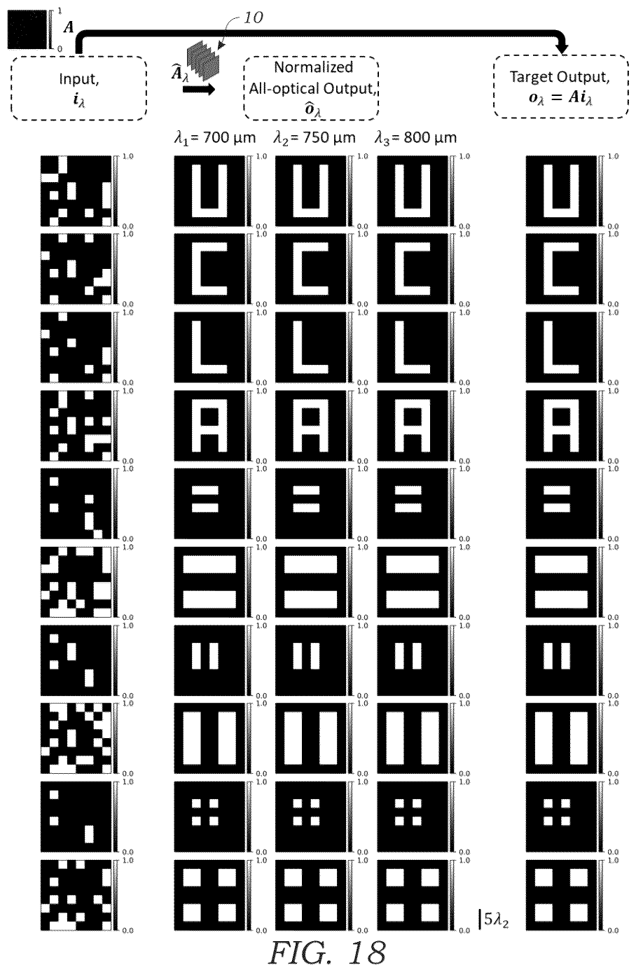

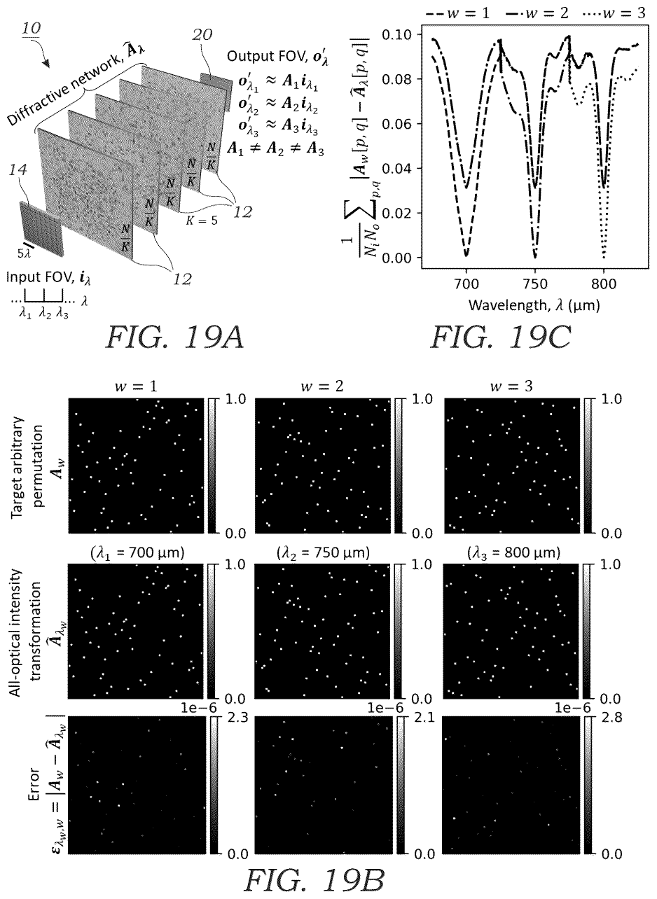

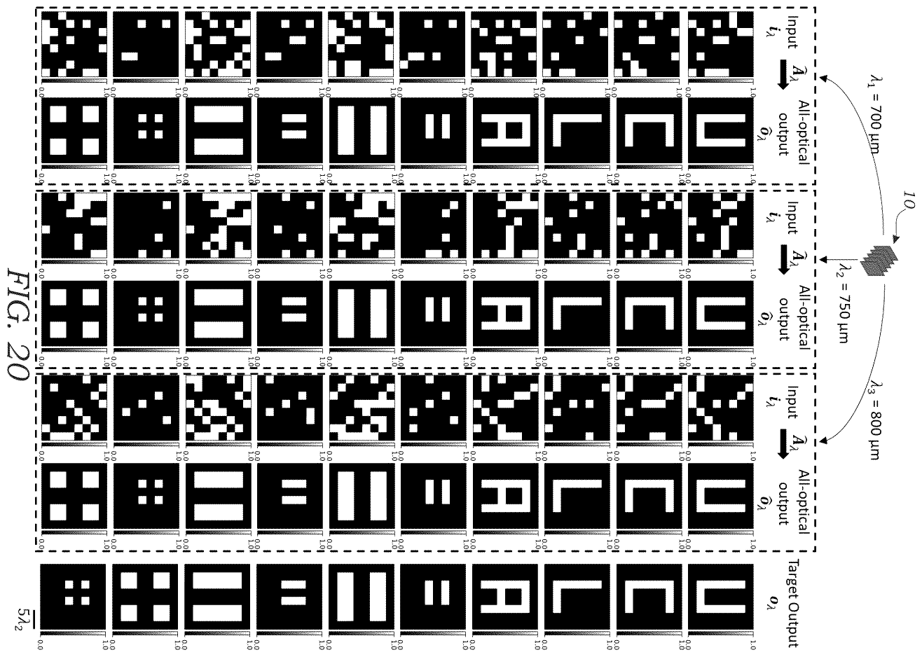

The capability of spatially incoherent diffractive networks 10 to all-optically perform arbitrary intensity linear transformations at different illumination wavelengths, operating simultaneously, is also demonstrated. For this purpose, consider two different cases: (1) the same intensity linear transformation A is simultaneously performed at N_{w}=3 discrete wavelengths λ₁, λ₂, λ₃ (see FIGS. 17A-17C, and 18), and (2) three unique intensity linear transformations A₁, A₂, A₃ are simultaneously performed at N_{w}=3 discrete wavelengths λ₁, λ₂, λ₃ (see FIGS. 19A-19C and 20). For the former, a spatially incoherent diffractive optical network 10 was trained to perform the same arbitrarily chosen permutation matrix A, as shown in FIG. 17B, at λ₁=700 μm, λ₂=750 μm, λ₃=800 μm. The all-optical transformations performed under spatially incoherent light at these three wavelengths, i.e., Â_{λ}_{₁}, Â_{λ}_{₂} and Â_{λ}_{₃} are also shown in FIG. 17B, together with the corresponding numerical error matrices. The plot of the average of the elements of the error matrices, corresponding to the all-optical transformations Â_{λ} at different wavelengths is seen in FIG. 17C. These results and analyses show that the spatially incoherent diffractive optical network 10 could simultaneously perform the target permutation with negligible error at these three wavelengths. In FIG. 18, visual examples of the all-optical permutations performed by the diffractive network 10 are depicted. Here, inverse-mapped intensities of recognizable test patterns were used as the input intensities; the diffractive network 10 was successful in all-optically reproducing the test patterns at the output FOV at all three wavelengths with no perceptible error, indicating Â_{λ}_{₁}≈Â_{λ}_{₂}≈Â_{λ}_{₃}≈A.

For the second case, where the goal is for the spatially incoherent inputs at λ₁, λ₂ and λ₃ to undergo three unique all-optical intensity linear transformations (A₁, A₂, A₃, respectively) by the same/common diffractive optical network 10, three arbitrary permutation matrices were chosen such that Σ_{p,q} Aᵢ[p, q]Aⱼ[p, q]=0 for i≠j. A spatially incoherent diffractive optical network 10 was trained to perform these distinct linear transformations A₁, A₂ and A₃ on the input intensities at λ₁=700 μm, λ₂=750 μm and λ₃=800 μm, respectively. FIG. 19B shows the target permutation matrices A₁, A₂, A₃, the resulting all-optical intensity transformations Â_{λ}_{₁}, Â_{λ}_{₂}, Â_{λ}_{₃} performed by the spatially incoherent diffractive network at wavelengths λ₁, λ₂, and λ₃ and the corresponding numerical error matrices. The average of the elements of the error matrices corresponding to the all-optical transformations Â_{λ} performed by the diffractive network at different wavelengths A is also plotted, with respect to the target permutations in FIG. 19C. The results of FIGS. 19B and 19C show that the spatially incoherent diffractive network 10 simultaneously performed the target permutation operations with negligible error at the three designated wavelengths. Apart from the negligible error at the wavelengths designated to the target transforms, the error also has local minima (~0.03125) at the other two wavelengths, as shown in FIG. 19C. This is due to the fact that the all-optical transformations at the other two wavelengths are also permutation operations and the maximum value of the mean absolute error between two unique/non-overlapping permutation matrices of size N×N is bounded by 2/N which is 0.03125 in this case, very well agreeing with the local minima observed in FIG. 19C. FIG. 20 also depicts some visual examples of the all-optical permutations simultaneously performed by the spatially incoherent diffractive optical network 10. Similar to FIG. 18, the inverse-mapped intensities of recognizable test patterns under A₁, A₂ and A₃ were used as the input intensities at λ₁=700 μm, λ₂=750 μm, λ₃=800 μm, respectively; the diffractive network 10 all-optically reproduced the test patterns at the output FOV 20 at all three wavelengths with no perceptible error, indicating Â_{λ}_{₁}≈A₁, Â_{λ}_{₂}≈A₂, and Â_{λ}_{₃}≈A₃.

Apart from these indirect and direct design approaches that are both based on data-driven supervised learning, an alternative, third design approach was used: a data-free method based on spatially varying PSFs. This spatially incoherent diffractive network design approach involves separately propagating each of the Nᵢ input pixels (see Eq. 20 of the ‘Methods’ section) and minimizing the MSE between the all-optical intensity transformation A′ and the target transformation A. Since this approach is based on optimizing the spatially varying PSFs of an incoherent diffractive network, it was called the PSF-based design approach that is data-free. To showcase the utility of this approach, another spatially incoherent diffractive optical network 10 was trained to perform the same intensity linear transformation A as in FIGS. 6A-6D through FIG. 14, with Nᵢ=Nₒ=8×8 and a diffraction-limited input/output pixel size of

$$- \frac{λ}{2} .$$

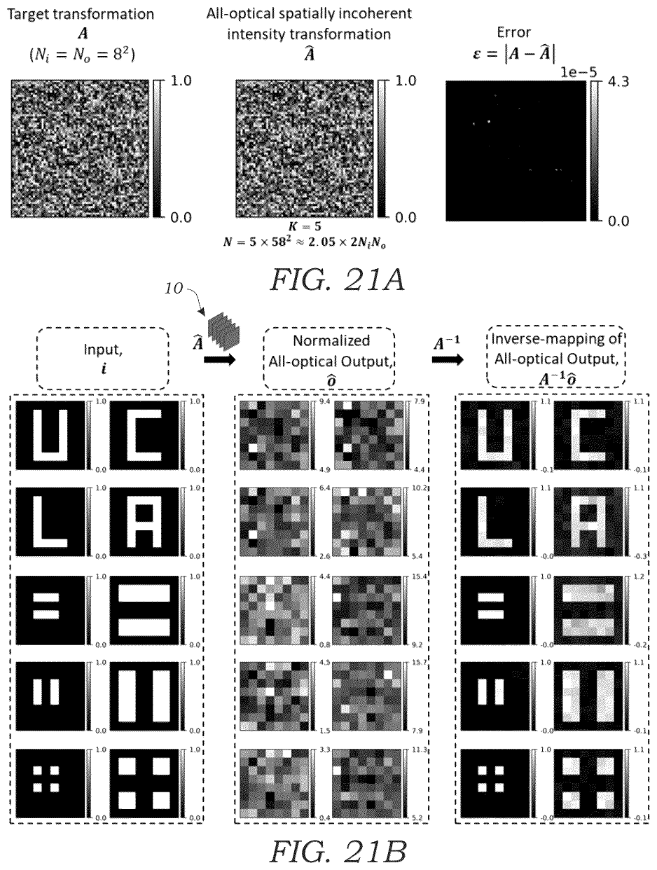

As for the diffractive network architecture, K=5,N=5×58²≈2.05×2NᵢNₒ was used. FIG. 21A shows the target intensity transformation A, the all-optical transformation matrix Â of the trained spatially incoherent diffractive network, and the error matrix ε=|A−Â|, revealing negligible error in achieving the target linear transformation. FIG. 16B shows the all-optical output 20 (i.e., intensities) for different input test patterns as the input optical signal or data 14, confirming the success of this spatially incoherent diffractive design using the data-free PSF-based approach.

### Discussion

It has been demonstrated that phase-only diffractive networks 10 under spatially-incoherent illumination 16 could perform arbitrary linear transformations of optical intensity with a negligible error if N ≥2NᵢNₒ. The same conclusions would be applicable to complex-valued diffractive networks 10 where the phase and amplitude of each diffractive feature could be independently optimized; in that case, the critical number of complex-valued diffractive features for approximating an arbitrary linear transformation of optical intensity would reduce by half to NᵢNₒ due to the increased degrees of freedom per diffractive layer 12. Because of the practical advantages of phase-only diffractive networks, without loss of generality, the analyses herein were limited to phase-only modulation at each diffractive surface.

The results suggest that the two different data-driven training approaches (indirect vs. direct design) converge differently. If N is comparable to or larger than 2Nᵢ Nₒ, the indirect approach results in significantly better and faster convergence and accurate approximation Â≈A; on the other hand, the direct design approach works better when N is considerably less than 2NᵢNₒ, even if its approximation error is larger. For example, although the designs #2A and #2B have higher errors than the design #1A, the performances of the former on various test patterns are manifestly better as compared in FIGS. 8, 9, 13 and 14. These direct designs can be further improved in their approximation power by increasing N_{φ,tr}>>1000 through a longer training phase, utilizing more computational resources.

A probable reason for the relatively inferior performance of the indirect design approach for N<2NᵢNₒ is the zero-phase restriction imposed on A̅[p, q], i.e., A̅[p, q]=\sqrt{A[p, q]} exp(j0). This zero-phase condition might restrict the convergence of the diffractive network design, given limited degrees of freedom, training data and time. Without any such phase restrictions assumed, the direct approach can converge to a relatively better solution for N<2NᵢNₒ, satisfying A[p, q]=|A̅[p, q]|². On the other hand, with N ≥2NᵢNₒ, i.e., with sufficient degrees of freedom available within the network architecture, it becomes easier to meet the additional phase constraint of the indirect design approach, while the direct approach still suffers from training noise arising from limited N_{φ,tr}; this trade-off is at the heart of the relatively inferior performance of the direct approach for N ≥2NᵢNₒ.

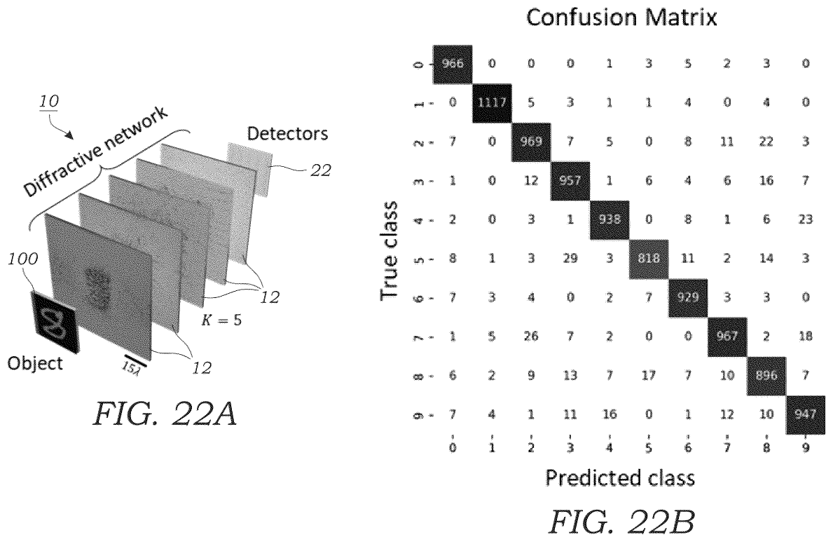

An important advantage of the direct approach over the indirect one is that the former can be applied even if the only information available to the designer is the sample data representing the target incoherent linear process, without a priori knowledge of the transformation matrix itself. By the same token, the direct approach also lends itself to data-driven optimization of incoherent diffractive processors for all-optical linear approximation of some nonlinear processes. As a consequence of this, data-driven design of incoherent processors for performing other inference tasks such as e.g., all-optical image classification under spatially incoherent illumination, can be accomplished using the direct approach. This important advantage of the direct approach was demonstrated through a practical application involving image classification, i.e., all-optical classification of MNIST handwritten digits under spatially incoherent illumination 16. In this scheme, the images are encoded in the intensity of the incoherent illumination 16, as depicted in FIG. 22A, while at the output plane (i.e., FOV of output optical signal or data 20) of the diffractive network, twenty detectors 22 were placed in a differential scheme, i.e., a positive detector and a negative detector for each of the 10 data classes. For training the spatially incoherent diffractive network, N_{φ,tr}=10 was used and a batch size of 64. Despite the less accurate forward model with a small N_{φ,tr}, a larger batch size bolstered the training process and facilitated better convergence. Once the model was trained, N_{φ,te}=20,000 was used for the blind testing, which resulted in a classification accuracy of 95.04%. The confusion matrix arising from this blind testing of the trained spatially incoherent diffractive network on 10,000 MNIST test images is shown in FIG. 22B. Further details on the training may be found in the Methods section, below.

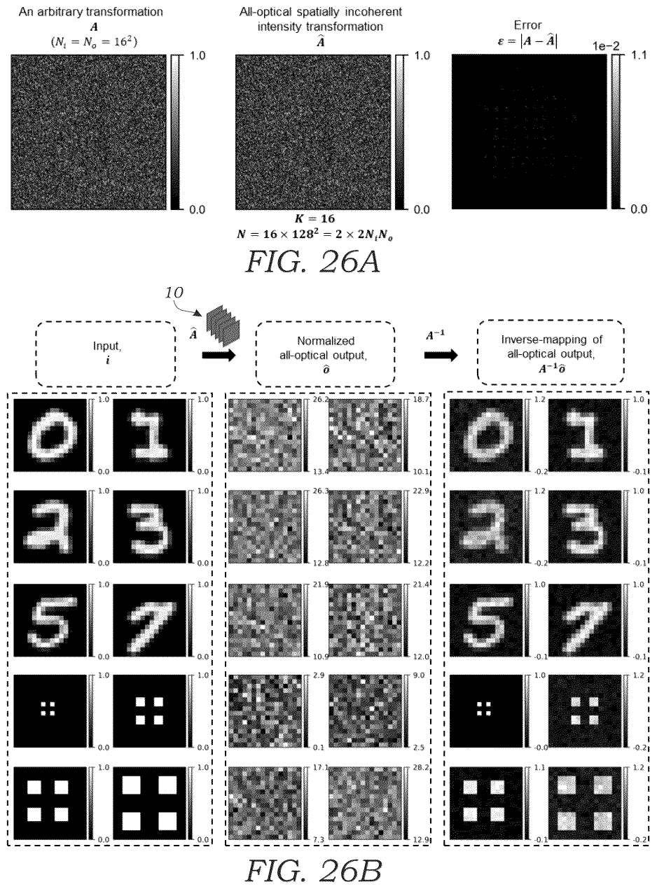

Both the indirect and the direct design approaches based on data-driven supervised learning suffer from diffraction efficiency fluctuations across the input pixels to some extent, manifested by the appearance of vertical stripes in some of the all-optical intensity transformations reported in e.g., FIGS. 10 and 12. This artifact arises from using a different scaling factor for each example during the training (see Eqs. 11 and 13). The artifact is not perceptible for the indirect approach in general, except for the K=2 design shown in FIG. 10 where the artifact is severe. The PSF-based data-free design approach, on the other hand, is free from such artifacts, as shown in FIGS. 21A-21B, while also being computationally more efficient. For example, the optimization of the spatially incoherent diffractive network reported in FIGS. 21A-21B using the data-free PSF-based design approach took less than 4 min. Benefiting from its speed, this PSF-based design approach was used to tackle a larger problem with Nᵢ=Nₒ=16×16 as illustrated in FIGS. 26A-26B, for which the optimization took less than 35 min. Despite these advantages, the PSF-based approach, like the indirect design method, cannot be used in the case of an unknown transformation, such as data-driven classification problems, as depicted in FIGS. 22A-22B.

The failure of shallow diffractive networks 10 to perform an arbitrary intensity transformation (see e.g., K=1 design shown in FIG. 10) indicates that shallow architectures with phase-only diffractive layers are unable to effectively balance the ballistic photons that are transmitted from the sample/input FOV over a low numerical aperture; as a result of this, the lower spatial frequencies of the input intensity patterns dominate the output intensity patterns of a shallow diffractive network, sacrificing the approximation accuracy. Therefore, shallow diffractive network architectures 10, even with large numbers (N) of trainable diffractive features 24, fail to approximate an arbitrary intensity transformation, as shown in FIG. 10. Deeper architectures, on the other hand, utilize their trainable diffractive features more effectively by distributing them across several layers/surfaces, one following another, and mixing the propagating modes of the input FOV over a series of layers that are optimized using deep learning.

As demonstrated in the Results section and FIGS. 17A-17C through FIG. 20, spatially-incoherent diffractive processors 10 can also be extended to operate under broadband illumination light. In fact, multiplexing of >150 arbitrary complex-valued linear transformations for complex optical fields was shown to be possible under spatially-coherent but broadband illumination light 16. Following a similar multi-wavelength optimization process and the indirect design principles outlined earlier, one can design a diffractive network 10 to simultaneously approximate M>150 arbitrarily-selected linear intensity transformations (A_{λ}_{₁}, A_{λ}_{₂}, . . . . A_{λ}_{_{M}}) under spatially-incoherent illumination, where each intensity transformation is assigned to a unique wavelength λᵢ{i=1:M}. The success of such a spatially- and temporally-incoherent diffractive optical network 10 to accurately perform all the target intensity transformations requires an increase in the number of trainable features within the diffractive volume, i.e., N≥M×2NᵢNₒ would be needed for a phase-only diffractive network. Such diffractive processor designs that work under spatially- and temporally-incoherent light can be useful for a number of applications, including fluorescence and brightfield microscopy and the processing of natural scenes.

Note that the analysis herein was limited to a relatively small problem size, e.g., Nᵢ=Nₒ=64 or Nᵢ=Nₒ=256 as in FIGS. 26A, 26B. Larger problems in terms of Nᵢ and Nₒ would necessitate diffractive designs with larger K and N, which in turn would necessitate a longer training phase with a larger training set for converging to a good solution. Even though the PSF-based design approach, as discussed above, could alleviate some of the computational burden, ultimately for megapixel-size input/output problems, distributed training over multiple computers might be necessary for implementing the large optical forward model. As for the physical implementation of a converged diffractive network model, fabrication methods such as lithography and additive manufacturing could be used for creating diffractive/substrate layers 12 for high-density incoherent visual computing at the visible and infrared wavelengths. While the physical alignment of these diffractive/substrate layers 12 might pose some practical challenges, the requirement for precise alignment can be relaxed by training the diffractive processor designs with such fabrication and alignment imperfections added as random physical variables during the training phase; this strategy has been shown to bring resilience against relative misalignments between the fabricated and assembled diffractive layers.

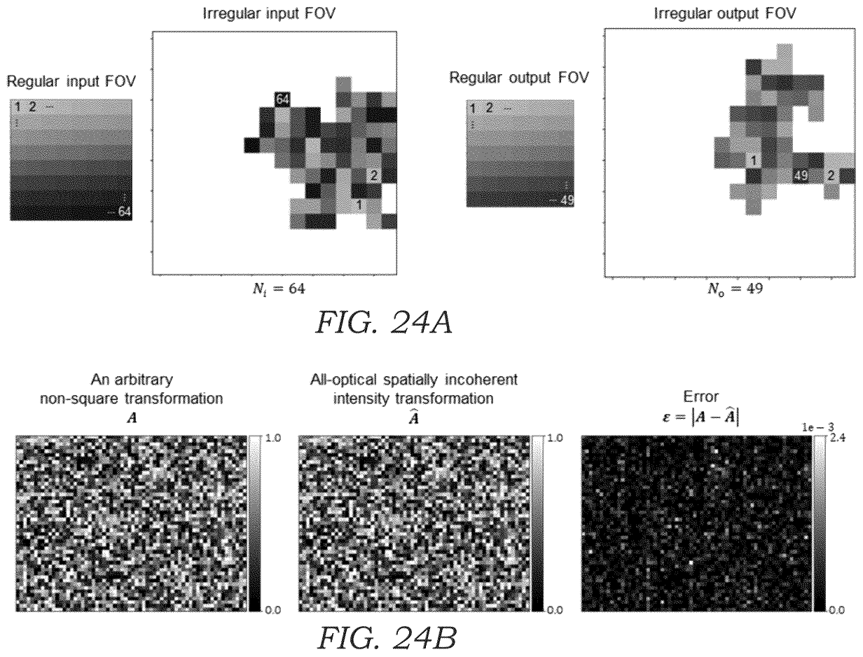

It should also be emphasized that the intensity linear transformations performed by diffractive networks 10 under spatially incoherent illumination 16 are not limited to square matrices with Nᵢ=Nₒ. To show this, a diffractive optical network was trained to perform an intensity linear transformation A with Nᵢ=64 and Nₒ=49, using the indirect design approach. To keep the solution space general, the pixels were distributed on the input and the output FOVs in an irregular manner (arbitrarily selected), completely deviating from the regular 8×8 and 7×7 grids (see FIG. 24A). FIG. 24B shows the all-optical intensity transformation Â performed by this trained spatially incoherent diffractive network 10, together with the target transformation A and the error matrix ε=|A−Â|, revealing a negligible transformation error in this case of Nᵢ≠Nₒ.

In addition, the previously discussed framework cannot process negative/complex-valued numbers in its current information encoding implementation since it uses optical intensity to represent information. However, it can be extended to implement complex-valued transformations by mapping and encoding the complex numbers, e.g., real and imaginary parts, as well as negative numbers to be represented by optical intensity. These complex-valued embodiments are further discussed below.

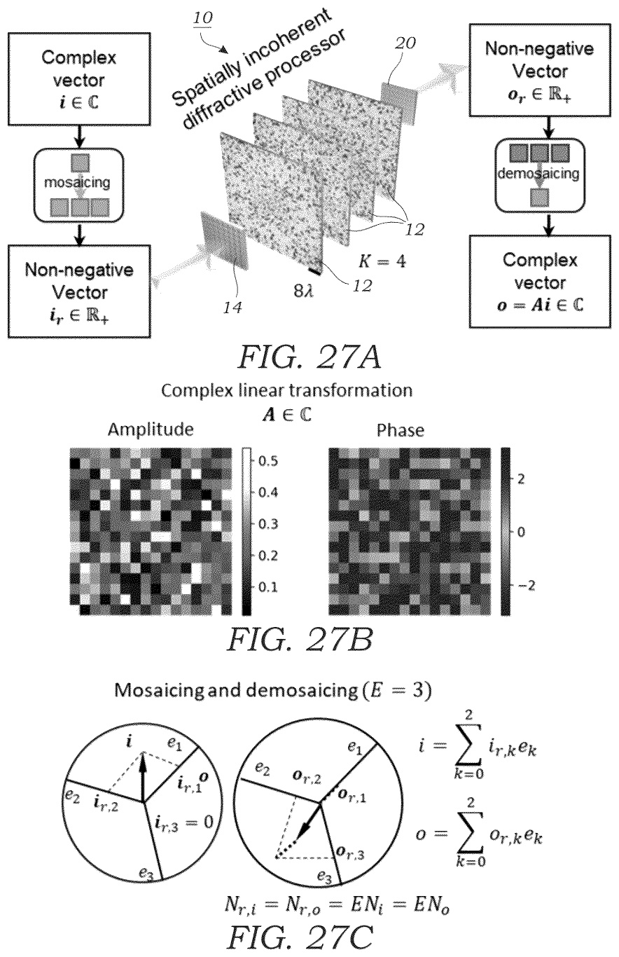

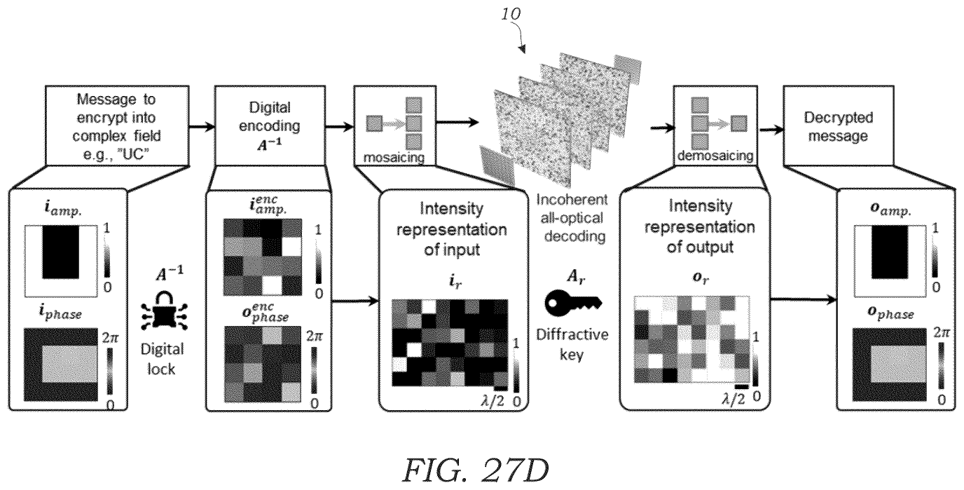

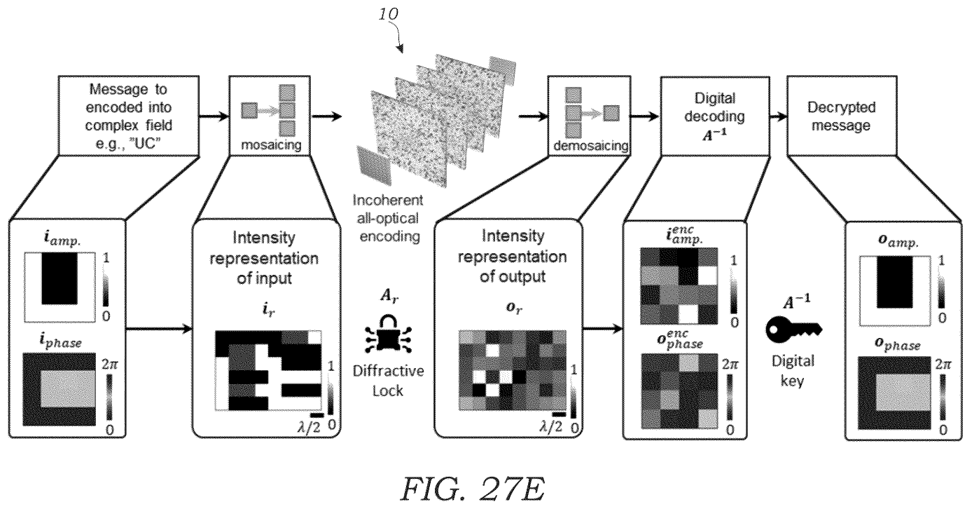

FIGS. 27A-27E illustrate embodiments of using spatially incoherent diffractive optical networks 10 for complex-valued universal linear transformations and image encryption. Here, the processing of complex-valued data is performed with a compact diffractive optical network 10 under spatially incoherent illumination. A spatially incoherent diffractive network 10 that axially spans <100×λ can perform any arbitrary complex-valued linear transformation on complex-valued input data with negligible error if the number of optimizable diffractive features 24 is above a threshold dictated by the multiplication of the input and output space-bandwidth products, determined by both the spatial extent and the pixel size of the input and output apertures. To represent complex-valued spatial information using spatially incoherent illumination, the input information was preprocessed by mapping complex-valued data to an optical intensity-based representation at the input field-of-view (FOV) of the diffractive network 10. This mapping is referred to as the ‘mosaicing’ operation in FIGS. 27A-27E, indicating the utilization of multiple intensity pixels at the input FOV 14 to represent one complex-valued input data point. Similarly, a postprocessing step was employed, which involved mapping the intensity patterns at the output FOV 20 back to the complex number domain, which is referred to as the ‘demosaicing’ operation. The demosaicing operation may be performed by a computing device or circuitry 120 (FIGS. 1A and 1B) that is configured to map intensity data obtained by the one or more image sensors or optoelectronic detectors 22 at the output FOV 20 into a complex-valued signal(s) or data that approximate the target linear transformation of the input optical signal(s) or data. Through these mosaicing/demosaicing operations, a spatially incoherent diffractive optical network 10 can be optimized to perform an arbitrary complex-valued linear transformation between its input and output apertures while providing optical information encryption. The spatially incoherent diffractive optical network or processor 10, with its universality and thin form factor (<100×2), shows significant promise for image encryption and computational imaging applications under natural light.

### Results-Complex-Valued Linear Transformations

FIG. 27A outlines a spatially incoherent diffractive optical network or processor 10 architecture to synthesize an arbitrary complex-valued linear transformation (A) such that o=Ai, where the input is i∈ [symbol] ^{N}^{ᵢ}, the target is o∈ [symbol] ^{N}^{ₒ} and A∈ [symbol] ^{N}^{ₒ}^{×N}^{ᵢ}. The mosaicing process involves finding the non-negative (optical intensity-based) representation of each complex-valued element of i using E non-negative values; here, E bases, eₖ, k=0, . . . , E−1 (see FIG. 27C), are used for representing the intensity-based encoding of complex numbers. Based on this representation, the 2D input aperture of a spatially incoherent diffractive optical network or processor 10 will have ENᵢ non-negative (optical intensity) values, denoted as

$${i}_{r} ∈ {ℝ}_{+}^{{EN}_{i}} ,$$

representing the input information under spatially incoherent illumination. The output intensity distribution, denoted with

$$\text{?} ∈ {ℝ}_{+}^{{EN}_{o}} ,$$

undergoes a demosaicing process where a complex number is synthesized from the intensity values of E output pixels, yielding the complex output vector ô∈ [symbol] ^{N}^{ₒ} such that ô≈Ai.

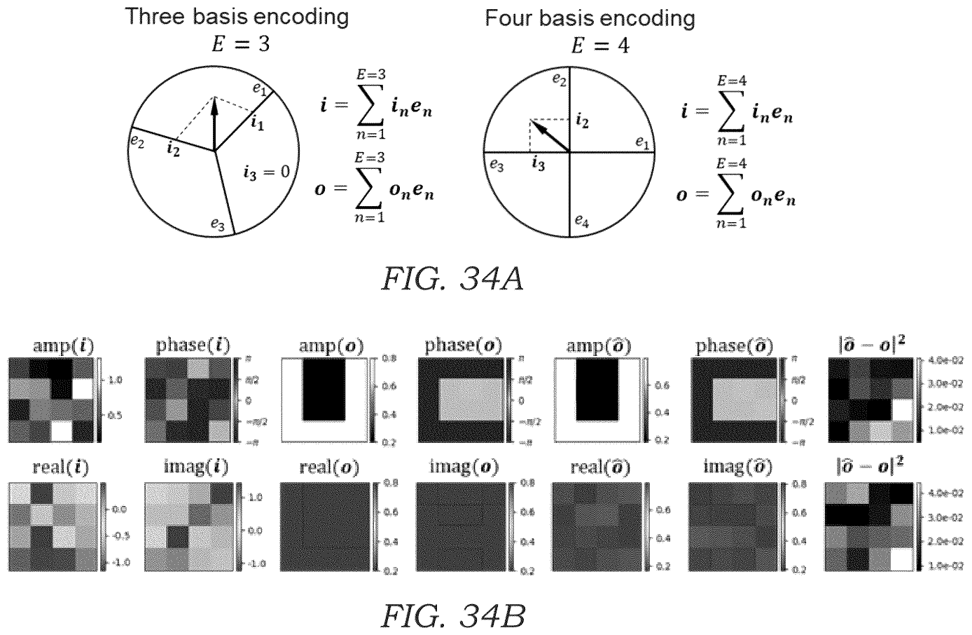

In these analyses, E=3, was used except in FIGS. 34A, 34B, where E=4 results are shown for comparison. The basis complex numbers was chosen as

$${e}_{k} = exp ( jk \frac{2 π}{E} ) ,$$

k=0, . . . , E−1 such that the set of bases S is closed under multiplication, and the product of any two of the bases in the set is also a basis; for example, for E=3 one has eₖeₗ=e_{(k+l mod 3)}. Based on this representation of information, with E=3 and e₀, e₁, e₂, one can decompose any arbitrarily selected complex valued transformation matrix A into E=3 matrices (A₀, A₁, A₂) with real non-negative entries such that:

$$A = {e}_{0} {A}_{0} + {e}_{1} {A}_{1} + {e}_{2} {A}_{2} \qquad ( 6 )$$

For a given complex-valued input i=e₀i₀+e₁i₁+e₂i₂, where iₖ∈ [symbol] ₊, the corresponding target output vector can be written as:

$$o = A i = ( {e}_{0} {A}_{0} + {e}_{1} {A}_{1} + {e}_{2} {A}_{2} ) ( {e}_{0} {i}_{0} + {e}_{1} {i}_{1} + {e}_{2} {i}_{2} ) \qquad ( 7 )$$

$$o = {e}_{0} ( {A}_{0} {i}_{0} + {A}_{2} {i}_{1} + {A}_{1} {i}_{2} ) + {e}_{1} ( {A}_{1} {i}_{0} + {A}_{0} {i}_{1} + {A}_{2} {i}_{2} ) + {e}_{2} ( {A}_{2} {i}_{0} + {A}_{1} {i}_{1} + {A}_{0} {i}_{2} ) \qquad ( 8 )$$

i.e., one has:

$${o}_{r} = [ \begin{matrix}{o}_{0} \\ {o}_{1} \\ {o}_{2}\end{matrix} ] = [ \begin{matrix}{A}_{0} & {A}_{2} & {A}_{1} \\ {A}_{1} & {A}_{0} & {A}_{2} \\ {A}_{2} & {A}_{1} & {A}_{0}\end{matrix} ] [ \begin{matrix}{i}_{0} \\ {i}_{1} \\ {i}_{2}\end{matrix} ] = {A}_{r} {i}_{r} \qquad ( 9 )$$

with a non-negative real-valued matrix Aᵣ:

$${A}_{r} = [ \begin{matrix}{A}_{0} & {A}_{2} & {A}_{1} \\ {A}_{1} & {A}_{0} & {A}_{2} \\ {A}_{2} & {A}_{1} & {A}_{0}\end{matrix} ] \qquad ( 10 )$$

For E=4, where eₖeₗ=e_{(k+l mod 4)} and A=e₀A₀+e₁A₁+e₂A₂+e₃A₃, a similar analysis yields:

$${A}_{r} = [ \begin{matrix}{A}_{0} & {A}_{2} & {A}_{3} & {A}_{1} \\ {A}_{2} & {A}_{0} & {A}_{1} & {A}_{3} \\ {A}_{1} & {A}_{3} & {A}_{0} & {A}_{2} \\ {A}_{3} & {A}_{1} & {A}_{2} & {A}_{0}\end{matrix} ] \qquad ( 11 )$$

Based on these equations, one can conclude that to all-optically implement an arbitrary complex-valued transformation o=Ai using a spatially incoherent diffractive optical network or processor 10, the diffractive/substrate layers 12 of the diffractive optical network or processor 10 need to be optimized to perform an intensity linear transformation

$${A}_{r} ∈ {ℝ}_{+}^{{E}^{2} {N}_{i} {N}_{o}}$$

such that oᵣ=Aᵣiᵣ. The entire system, upon convergence, performs the predefined complex-valued linear transformation A on any given input data using spatially incoherent light—based on Eqs. 2 and 4. In the following sections, the number (N) of optimizable diffractive features 24 needed for accurate approximation of A using a spatially incoherent diffractive optical network or processor 10 is numerically explored.

### Complex-Valued Linear Transformations Through Spatially Incoherent Diffractive Networks

The capabilities of diffractive optical networks or processors 10 were numerically demonstrated to universally perform any arbitrarily chosen complex-valued linear transformation with spatially incoherent light. Nᵢ=Nₒ=16 was used for the diffractive optical networks or processors 10. To visually represent the data, the 16-element vectors were rearranged into 4×4 arrays of complex numbers, hereafter referred to as the “complex image.” A desired complex-valued transformation, A∈ [symbol] ^{16×16}, was arbitrarily selected as shown in FIG. 27B.

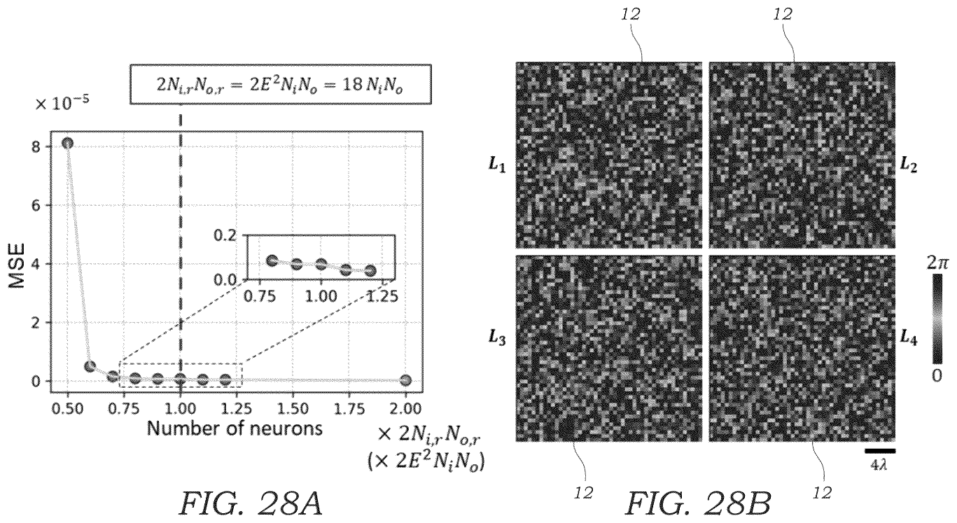

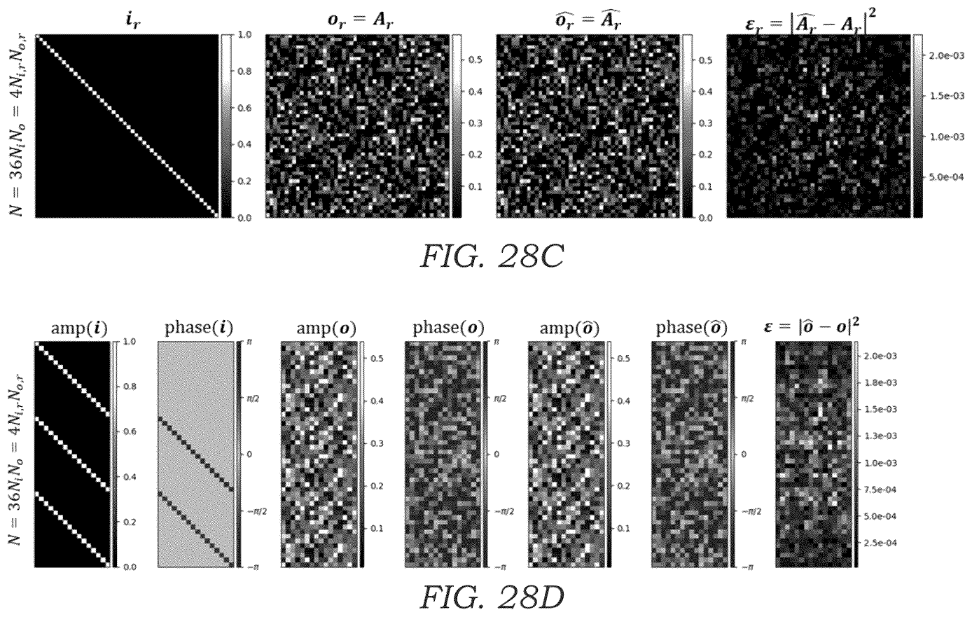

To explore the number of diffractive features 24 needed, nine models were trained with varying values of N and evaluated the mean-squared-error (MSE) between the numerically measured ( [symbol] ) and the target all-optical linear transformation, Aᵣ (see FIG. 28A). The results summarized in FIGS. 28A-28D highlight that with a sufficient number of optimizable diffractive features, i.e., N ≥2E²NᵢNₒ=2N_{i,r}N_{o,r} the diffractive optical network or processor 10 achieves a negligible approximation error with respect to the target

$${A}_{r} ∈ {ℝ}_{+}^{48 \times 48} .$$

In FIG. 28C shows the visualized results of the all-optical intensity transformation [symbol] compared to the ground truth Aᵣ. In essence, this comparison reveals the spatially varying incoherent point-spread-functions (PSFs) of the diffractive system optimized using deep learning; a negligible MSE between [symbol] and Aᵣ shows that the resulting spatially varying incoherent PSFs match the target set of PSFs dictated by Aᵣ.

The numerical accuracy of the complex-valued transformation was also evaluated in an end-to-end manner, as illustrated in FIG. 28D. For this numerical test, each entry of i was sequentially set to e₀ and the corresponding complex output ô was evaluated and stacked to form [symbol] , where the subscript represents that the measurement was evaluated using the complex impulse along the basis e, as input. Then, this process was repeated for the other two bases to obtain [symbol] and [symbol] , and stacked these matrices as a block matrix [ [symbol] | [symbol] | [symbol] ] shown in FIG. 28D. Each row of the images amp(ô) and phase(ô) in FIG. 28D represents one of these complex output vectors, while the corresponding target vectors are presented in the same figure through amp(o) and phase(o). The small magnitude of the error ε=|ô−o|² shown in FIG. 28D illustrates the success of this spatially incoherent diffractive optical network or processor model in accurately approximating the complex-valued linear transformation o=Ai, implemented for an arbitrarily selected A.

### Complex Number-Based Image Encryption Using Spatially Incoherent Diffractive Networks.

Here, a complex number-based image encryption-decryption scheme using a spatially incoherent diffractive optical network or processor 10. In the first scheme shown in FIG. 27D, the message which corresponds to the input optical signal or data 14 is encoded into a complex image, employing either amplitude and phase encoding or real and imaginary part encoding. Then, a digital lock encrypts the image by applying a linear transformation (A⁻¹) to conceal the original message within the image. At the optical receiver, the encrypted message is deciphered by an optimized incoherent diffractive optical network or processor 10 that all-optically implements the inverse transformation A to generate the message as the output optical signal or data 20. In an alternative scheme, as depicted in FIG. 27E, the key and lock are switched, i.e., the spatially incoherent diffractive optical network or processor 10 is used at the front-end to encrypt the message with a complex-valued A while the decryption step involves the digital inversion using A⁻¹.

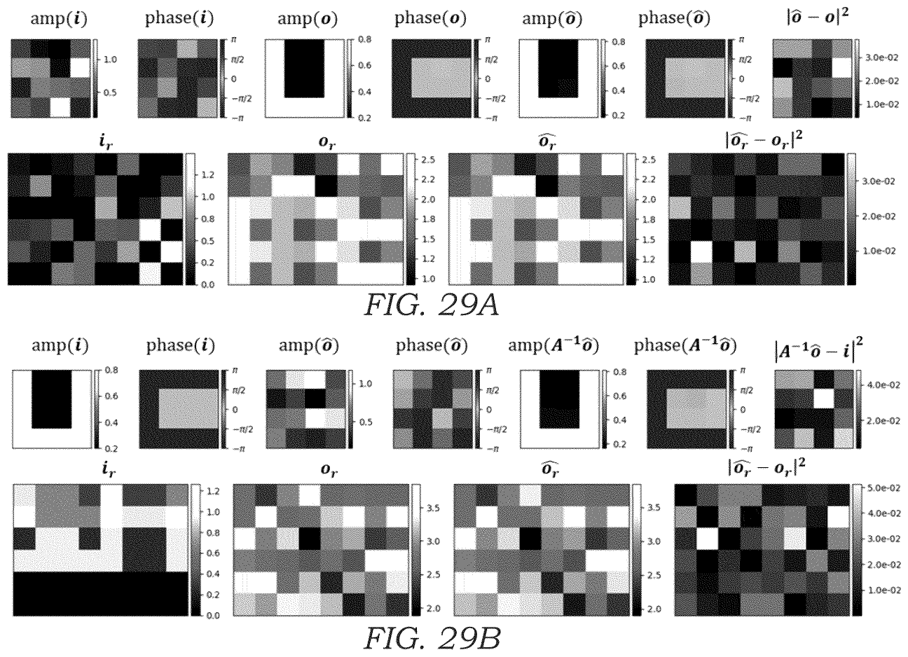

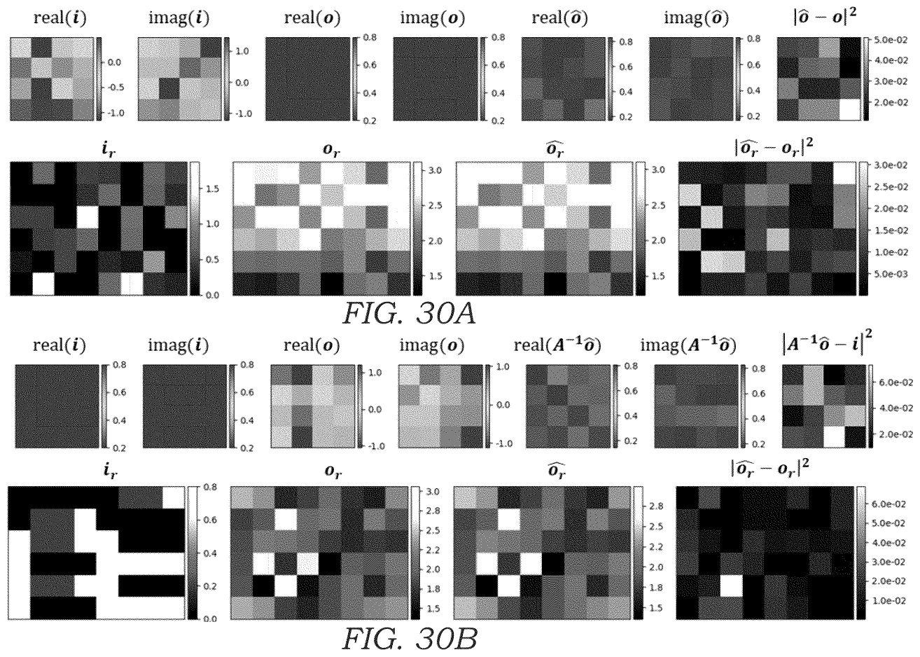

For this analysis, the letters ‘U’, ‘C’, ‘L’, ‘A’ were used as sample messages. ‘U’ and ‘C’ are used in amplitude-phase based encoding (FIGS. 29A-29B), whereas ‘L’ and ‘A’ are used for real-imaginary based encoding of information (FIGS. 30A, 30B), forming complex-number-based images. To accurately model the spatially incoherent propagation of light through the spatially incoherent diffractive optical network or processor 10, the output intensities were averaged over a large number N_{φ}=20,000 of randomly generated 2D phase profiles at the input (see Methods section for details).

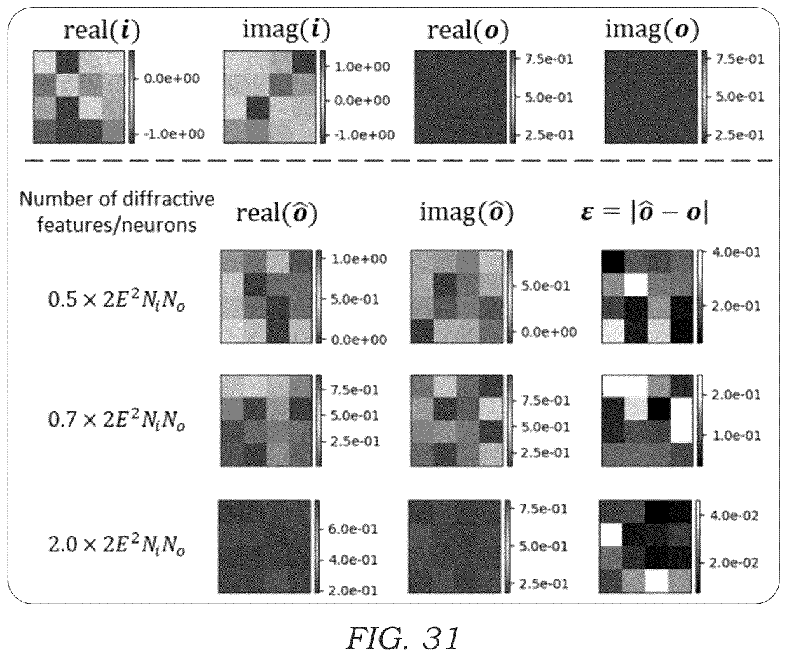

In FIG. 29A, results are shown corresponding to digital encryption and optical diffractive decryption, i.e., the system shown in FIG. 27D. The digitally encrypted complex information i=A⁻¹o, together with its intensity representation iᵣ, are shown in FIG. 29A. The optically decrypted output ô (through the spatially incoherent diffractive optical network or processor 10) and its intensity-based representation [symbol] are shown in the same FIG. 29A, together with the resulting error maps, i.e., |ô−o|² and | [symbol] −oᵣ|², which reveal a very small amount of error. This agreement of the recovered and the ground truth messages in both the intensity and complex-valued domains confirms the accuracy of the diffractive decryption process through an optimized spatially incoherent diffractive optical network or processor 10. FIG. 29B shows the successful performance of the sister scheme (FIG. 27E), which involves diffractive encryption through a spatially incoherent diffractive optical network or processor 10 and digital decryption, also revealing a negligible amount of error in both |A⁻¹ô−i|² and | [symbol] −oᵣ|². Reported in FIGS. 30A, 30B, a numerical experiment was also conducted using the letters ‘L’ and ‘A’, encoded using the real and imaginary parts of the message. The visualizations are arranged the same way as in FIGS. 29A-29B, where for both schemes depicted in FIG. 27D, 27E, the amount of error between the recovered and the original messages is negligible, affirming the success of using the real and imaginary part-based encoding method. For the assessment of the approximation errors when the number of diffractive features 24 is smaller, the decryption performance of three models was compared with different numbers of diffractive features 24/neurons, i.e., N=(0.5, 0.7, 2)×2E²NᵢNₒ, for the same setup outlined in FIG. 30A. The results are summarized in FIG. 31: for models with N<2E²NᵢNₒ, the decryption quality is compromised, exhibiting a pixel absolute error of >0.1. However, this error reduces to <0.05 for N=4E²NᵢNₒ where the decrypted images display significantly enhanced contrast and reduced noise levels.

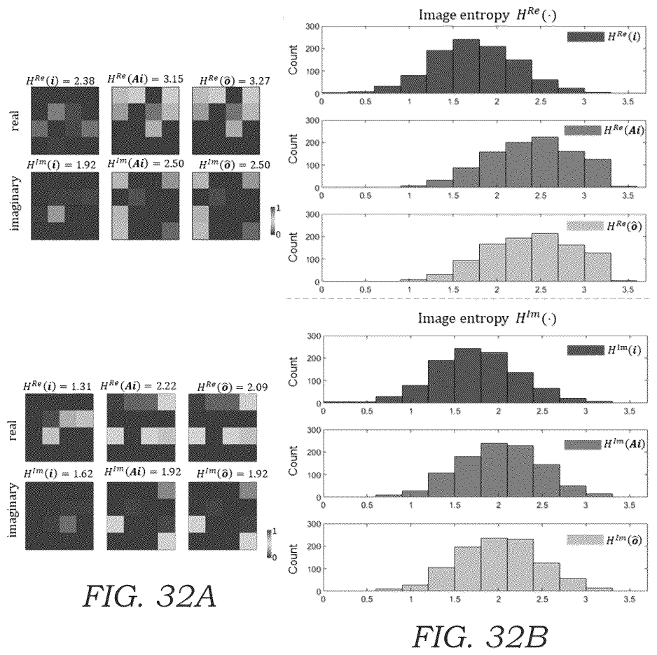

To further evaluate the efficacy of the encryption method, the complex image entropy was examined, including examining both the real and imaginary components separately (refer to the Methods section for details). The original image i, spatially incoherent diffractive optical network or processor-encrypted output ô and the digitally encrypted output Ai, along with the corresponding image entropies, are shown in FIG. 32A for two complex image examples. This analysis was repeated for a set of 1,000 complex images with the resulting entropy distributions reported in FIG. 32B. These results demonstrate that the entropy of the encrypted images is statistically higher than that of the original images. This increase in entropy signifies a heightened level of randomness within the encrypted images, thereby validating the effectiveness of the encryption process. In addition, the entropy distributions of the spatially incoherent diffractive optical network or processor-encrypted images show excellent agreement with the digitally encrypted corresponding images, further demonstrating the success of the spatially incoherent optical encryption scheme.

### Different Mosaicing and Demosaicing Schemes in a Spatially Incoherent Diffractive Optical Network or Processor

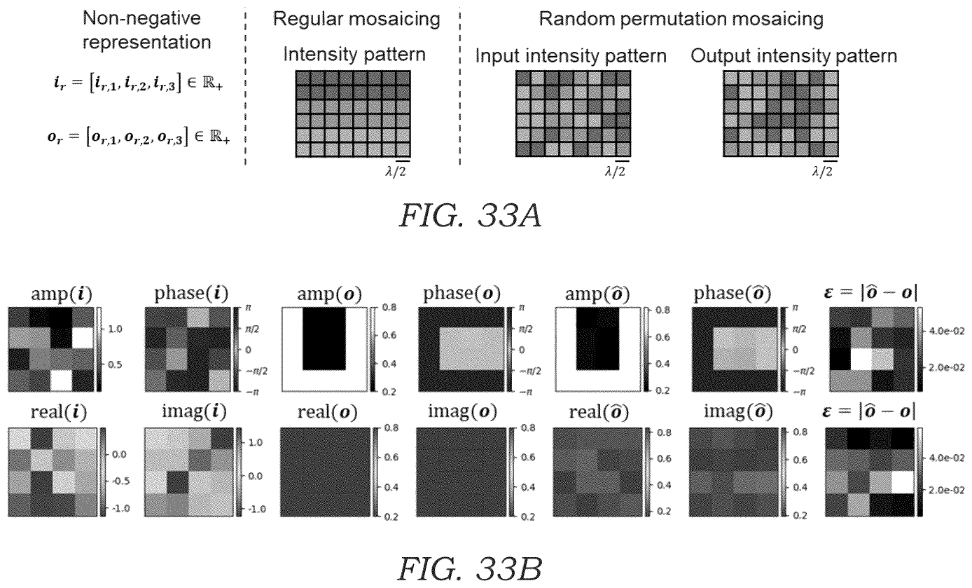

How each element in the vector iᵣ and oᵣ is assigned to the pixels at the input and output FOVs 14, 20 of the diffractive network 10 does not affect the final accuracy of the image/message reconstruction. For example, the FOVs 14, 20 can be arranged in such a manner that the components i_{r,k} corresponding to a basis eₖ are assigned to the neighboring pixels, in two adjacent rows, as shown in FIG. 33A; in an alternative implementation, the assignment/mapping can be completely arbitrary, which is equivalent to applying a random permutation operation on the input and output vectors (see the Methods section). When compared to each other, these two approaches of mosaicing and demosaicing schemes show negligible differences in the error of the final reconstruction of the letters ‘U’, ‘C’, ‘L’, ‘A’ as shown in FIG. 33B. These results underscore that the specific arrangement of the mosaicking/demosaicing schemes at the input and output FOVs 14, 20 does not impact the performance of the spatially incoherent diffractive optical network or processor 10.

Here, a data-free PSF-based spatially incoherent diffractive optical network or processor optimization method was employed (see the ‘Methods’ section) since one can determine the non-negative intensity transformation Aᵣ from the target complex-valued transformation A based on the mosaicing and demosaicing schemes; the columns of Aᵣ represent the desired spatially varying PSFs of the spatially incoherent diffractive optical network or processor 10. The advantage of this data-free learning-based diffractive processor optimization approach is that computationally demanding simulation of wave propagation with large N_{φ} is not required during the training. Coherent propagation is appropriate for simulating the spatially varying PSFs, point-by-point, since a point emitter at the input aperture coherently interferes with itself during optical diffraction within a spatially incoherent diffractive optical network or processor 10; this approach makes the training time much shorter. On the other hand, this approach necessitates prior knowledge of Aᵣ, which might not always be available, e.g., for tasks such as data classification. An alternative to this data-free PSF-based optimization approach is to train the diffractive network 10 in an end-to-end manner, using a data-driven direct training approach. This strategy advances by minimizing the differences between the outputs and the targets on a large number of randomly generated examples, thereby learning the spatially varying PSFs implicitly from numerous input-target intensity patterns corresponding to the desired task-instead of learning from an explicitly predetermined Aᵣ. This direct approach, however, requires a longer training time, necessitating the simulation of incoherent propagation for each training sample on a large dataset.

In the presented approach, the choice of E is not restricted to E=3, as was used throughout herein. As another example of encoding, the image encryption results are shown with E=4 in FIGS. 34A, 34B, where the four bases are

$$exp j \frac{π}{2} k$$

(k=0, 1, 2, 3). The reconstructed ‘U’, ‘C’, ‘L’, ‘A’ letters are also reported in the same figure, confirming that given sufficient degrees-of-freedom (with N ≥2E²NᵢNₒ), the linear transformation performances are similar to each other. However, compared to E=3, this choice of E=4 necessitates 4/3 times more pixels on both the diffractive network input FOV 14 and output FOV 20—reducing the throughput (or spatial density) of complex-valued linear transformations that can be performed using a spatially incoherent diffractive optical network or processor 10. Accordingly, more diffractive features 24 and a larger number of independent degrees of freedom (by 16/9-fold) are required within the spatially incoherent diffractive optical network or processor 10 volume to achieve an output performance level that is comparable to a design with E=3. Note that while E ≥3 is sufficient to reconstruct the original complex-valued images regardless of the image complexity, the redundancy provided by larger E values might offer increased resilience against noise at the cost of reducing the image processing throughput (per input aperture area) with larger E.

This framework offers several flexibilities in implementation, which could be useful for different applications. First, the flexibility to arbitrarily permute the input and the output pixels following different mosaicing and demosaicing schemes could enhance the security of optical information transmission. A user would not be able to either spam or hack valuable information that is transferred optically without specific knowledge of the mosaicing and demosaicing schemes, thus ensuring the security of this scheme. Note that this enhancement in security is achieved without adding complexity to the system by just permuting the assignment of data elements to the pixels of the input and output devices, e.g., spatial light modulators (SLM) and complementary metal-oxide-semiconductor (CMOS) detector-arrays. Second, the flexibility in choosing E, as discussed above, could be useful in adding an extra layer of security against unauthorized access, albeit with a trade-off in system throughput that comes with larger E. Furthermore, one can use different sets of bases for mosaicing and demosaicing operations by applying offset phase angles θᵢ and θₒ, respectively, to the original bases

$${e}_{k} = exp ( jk \frac{2 π}{E} ) ,$$

k=0, . . . , E−1. This will result in a set of modified/encrypted bases:

$${e}_{k , i} = exp ( j ( k \frac{2 π}{E} + {θ}_{i} ) )$$

for mosaicing and

$${e}_{k , o} = exp ( j ( k \frac{2 π}{E} + {θ}_{o} ) )$$

for demosaicing. This powerful flexibility in representation further enhances the security of the system.

Although spatially coherent light is more suitable for complex-valued information processing in laboratory settings, the use of spatially incoherent light 16 offers various practical advantages. For example, speckle noise, which is inevitable in coherent systems, can be suppressed by using partially or fully incoherent illumination. An additional benefit of spatially incoherent designs is the range of viable illumination sources that can be used: instead of using specialized coherent sources, a spatially incoherent system can work with standard light-emitting diodes (LEDs), or even under natural light, which is important for some applications of diffractive information processing.

The capability of spatially incoherent diffractive networks 10 to perform arbitrary complex-valued linear transformations has been demonstrated. By incorporating various forms of mosaicing and demosaicing operations, this paves the way for a wider array of applications by leveraging spatially incoherent diffractive optical networks or processors 10 for complex-valued data processing. Potential applications of these spatially incoherent diffractive optical networks or processors 10 include complex number-based image encryption or decryption, highlighting the security benefits arising from the system's flexibility. This marks a significant stride toward enhanced versatility and robustness in optical information processing with spatially incoherent diffractive systems that can work under natural light.

### Methods

### Model for the Propagation of Spatially-Coherent Light Through a Diffractive Optical Network

Propagation of spatially-coherent complex optical fields through a diffractive processor 10, [symbol] {·} constitutes successive amplitude and/or phase modulation by diffractive surfaces, each followed by coherent propagation through the free space separating consecutive diffractive surfaces 12. The diffractive features 24 of a surface locally modulate the incident optical field u (x, y). Here, the trainable diffractive features 14 are phase-only, i.e., only the phase, but not the amplitude, of the incident field is modulated by the diffractive surface. In other words, the field immediately after the surfaces would be u(x, y)exp(jφ_{M}(x, y)) where the local phase change φ_{M} (x, y) induced by the surface is related to its height h(x, y) as

$${ϕ}_{M} = \frac{2 π}{λ} ( n - 1 ) h .$$

Here n is the refractive index of the diffractive surface material.

Free-space propagation of an optical field between consecutive diffractive surfaces 12 was modeled using the angular spectrum method, according to which the propagation of an optical field u(x, y) by distance d can be computed as follows:

$$u ( x , y ; z = {z}_{0} + d ) = {ℱ}^{- 1} \{ ℱ \{ u ( x , y ; z = {z}_{0} ) \} \times H ( {f}_{x} , {f}_{y} ; d ) \} \qquad ( 12 )$$

where [symbol] ( [symbol] ⁻¹) is the two-dimensional Fourier (Inverse Fourier) transform and H(ƒₓ, ƒ_{y}; d) is the free-space transfer function for an axial propagation distance d:

$$H ( {f}_{x} , {f}_{y} ; d ) = \{ \begin{matrix}exp ( j \frac{2 π}{λ} d \sqrt{1 − {( λ {f}_{x} )}^{2} − {( λ {f}_{y} )}^{2}} ) , & {f}_{x}^{2} + {f}_{y}^{2} < 1 / {λ}^{2} \\ 0 , & otherwise\end{matrix} \qquad ( 13 )$$

where λ is the wavelength of light.

### Model for the Propagation of Spatially-Incoherent Light Through a Diffractive Optical Network

With spatially-incoherent light, the (average) output optical intensity O(x, y) of a diffractive network, for a given input intensity I(x, y), can be written as

$$O ( x , y ) = 〈 {\vert \text{?} \{ \sqrt{I ( x , y )} exp ( j φ ( x , y ) ) \} \vert}^{2} 〉 = {lim}_{{N}_{φ} \to ∞} {\sum }_{r = 1}^{{N}_{φ}} \vert \text{?} \{ \sqrt{1 ( x , y )} exp ( j {φ}_{r} ( x , y ) ) \} {\vert}^{2} \qquad ( 14 )$$

where [symbol] {·} denotes the coherent propagation of the optical field through the diffractive processor 10 as described in the preceding subsection, and [symbol] · [symbol] denotes the statistical average, over all the realizations of the spatially-independent random process φ(m, n) representing the 2D phase of the input optical field, i.e., φ(m,n)~U(0,2π) for all m, n.

As for the spatially-incoherent propagation of average intensity, it is only possible to approximate the true average (Eq. 14) by averaging over a finite number N of samples of φ(x,y), i.e.,

$$O ( x , y ) \approx \frac{1}{{N}_{φ}} {\sum }_{r = 1}^{{N}_{φ}} {\vert \text{?} \{ \sqrt{I ( x , y )} exp ( j {φ}_{r} ( x , y ) ) \} \vert}^{2} \qquad ( 15 )$$

In the training phase of the direct training approach, incoherent propagation of intensities through the diffractive processors 10 was simulated with N_{φ,tr}=1000. However, in the blind testing phase N_{φ,te}=20000 was used while evaluating the diffractive processors 10 once they were trained, irrespective of whether the indirect or the direct approach of training was used.

In the numerical simulations, the fields/intensities were discretized using δ≈0.53λ along both x and y, e.g., u(m, n)≙u(mδ, nδ) and sufficiently zero-padded before evaluating the Fourier transform, as in Eq. 12, using Fast Fourier Transform (FFT) algorithm. In particular, the fields were zero-padded such that the simulation window size after padding was four-times the size of the largest aperture, which in this case is the diffractive layer width. Such sampling ensured that the propagation distance d was smaller than the largest propagation distance for which the angular spectrum method is valid, satisfying the sampling requirement for accurate diffraction calculations.

The angular spectrum method, which was used to model the light propagation between diffractive layers 12, is a Fourier transform-based fast implementation of the Rayleigh-Sommerfeld diffraction integral. By using the Rayleigh-Sommerfeld model of diffraction, it is implicitly assumed that the light traveling through these layers 12 can be represented as a scalar field. While the accurate modeling and computation of diffracted light fields from structures with deeply subwavelength features require the use of vector diffraction theory, certain assumptions were made that allowed us to utilize the scalar field approximation. Firstly, it was assumed that the diffractive layers 12 are axially separated from each other by more than a wavelength (d>>λ), prohibiting the coupling of evanescent fields from one layer to the next. Secondly, the smallest feature size on a diffractive layer 12 was considered to be approximately half a wavelength. These assumptions permitted the approximation of the spatial information flow within a diffractive optical network using scalar optical fields.

### Diffractive Network Architecture

The heights h(m, n)≙h(mδ, nδ) of the N diffractive features distributed over K surfaces were optimized for designing the diffractive processors 10 to perform the desired transformation. To keep the connectivity between successive diffractive layers 12 the same across the trained diffractive networks 10 with different N, the layer-to-layer separation was set as

$$d = \frac{W δ}{λ} , where W = \sqrt{\frac{N}{K}} δ$$

is the width of each diffractive layer 12. The distances set as between the input FOV and layer−1 and between layer−K and the output FOV were also set as d. The pixel size on both the input and the output FOVs was ~2.13λ×2.13λ, i.e., 4δ×4δ.

### Linear Transformation Matrix

Here, the input 14 and the output 20 of the diffractive networks 10 have dimensions of Nᵢ=Nₒ=8×8, i.e., I,

$$O ∈ {\text{?}}_{+}^{8 \times 8} and i , o ∈ {\text{?}}_{+}^{64} .$$

To clarify, i and o are one-dimensional (column) vectors obtained by rearranging the intensity values I(m, n) and O(m, n) of the input and the output pixels arranged in a two-dimensional 8×8 square grid. Accordingly, the target transformation matrix A has a size of Nₒ×Nᵢ=64 ×64, i.e.,

$$A ∈ {\text{?}}_{+}^{64 \times 64} .$$

### The Indirect Approach of Training

Dataset preparation: In the indirect approach, instead of training the diffractive networks 10 to perform the linear transformation A between the input and the output intensities, the diffractive networks 10 were trained to perform the complex-valued linear transformation A̅ between the input and the output fields such that A̅[p, q]=\sqrt{A[p, q]} exp(j0). To prepare the dataset for such training, input field vectors ĩ with complex-valued elements were first generated, where the amplitudes were sampled independently from each other from the uniform distribution Uniform(0,1) and the phases from the distribution Uniform(0,2π) Then the relationship õ=A̅ĩ was used to generate the target ground truths for the corresponding output field vectors. 160,000 such pairs were generated and were split into training and validation sets with a ratio of 15:1.

Loss function: MSE was used between the target output field and the all-optical output field of the diffractive processor as the loss function to minimize for optimizing the diffractive surface thicknesses, i.e., the loss function was defined as:

$${ℒ}_{indirect} = \frac{1}{{N}_{o}} {\sum }_{l = 1}^{{N}_{o}} {\vert \overline{\overline{σ}} \tilde{o} [ l ] - \overline{\overline{σ}} {\tilde{o}}^{′} [ l ] \vert}^{2} \qquad ( 16 )$$

where õ′ is the diffractive network output field evaluated by coherent propagation of the input field through the diffractive network, σ̅ and σ̅′ are normalization factors defined as:

$$\overline{\overline{σ}} = {( {\sum }_{l = 1}^{{N}_{o}} {\vert \tilde{o} [ l ] \vert}^{2} )}^{- \frac{1}{2}} , \qquad ( 17 )$$

$${\overline{\overline{σ}}}^{′} = \frac{{\sum }_{l = 1}^{{N}_{o}} \overline{\overline{σ}} \tilde{o} [ l ] {\tilde{o}}^{′ *} [ l ]}{{\sum }_{l = 1}^{{N}_{o}} {\vert {\tilde{o}}^{′} [ l ] \vert}^{2}}$$

### The Direct Approach of Training

Dataset preparation: To prepare the dataset for training diffractive processors 10 for a given transformation A with the direct approach, input intensity vectors i were generated with elements (pixel values) sampled independently from each other from the uniform distribution Uniform(0,1). Corresponding ground truths for the output intensity vectors were calculated as o=Ai. In total, 160,000 pairs of intensity vectors were generated and split into training and validation sets with a ratio of 15:1.

Loss function: The loss function was defined as follows:

$${ℒ}_{direct} = \frac{1}{{N}_{o}} {\sum }_{l = 1}^{{N}_{o}} {( σ o [ l ] - {σ}^{′} {o}^{′} [ l ] )}^{2} \qquad ( 18 )$$

where o′ is the diffractive network output intensity evaluated by simulating incoherent propagation of the input intensity through the diffractive network, σ and σ′ are normalization factors defined as:

$$σ = {( {\sum }_{l = 1}^{{N}_{o}} {( o [ l ] )}^{2} )}^{- \frac{1}{2}} , \qquad ( 19 )$$

$${σ}^{′} = \frac{{\sum }_{l = 1}^{{N}_{o}} σ o [ l ] {o}^{′} [ l ]}{{\sum }_{l = 1}^{{N}_{o}} {( {o}^{′} [ l ] )}^{2}}$$

Note that during the training of the diffractive networks 10, the diffraction efficiency was not forced to be uniform across training examples and as a result the scaling factor for the output intensity

$$\frac{{σ}^{′}}{σ}$$

varies for different inputs. Therefore, the diffractive networks 10 trained using the direct approach exhibit unbalanced diffraction efficiency across the input pixels, as indicated by the uneven brightness across the columns (see e.g., FIG. 12); however, with increasing N, such unbalance becomes less severe. Although the same is true for the indirect approach, this unbalance in diffraction efficiency is less severe, except for the K=2 design shown in FIG. 10.

### The PSF-Based Data-Free Design Approach

The PSF-based optimization was performed by minimizing the MSE loss between the all-optical intensity transformation A′ performed by the spatially incoherent diffractive network and the target transformation A. To evaluate A′, Nᵢ intensity vectors

$${\{ {i}_{t} \}}_{t = 1}^{{N}_{i}}$$

were used where iₜ[I]=1 if l=t and 0 otherwise. In other words,

$${\{ {i}_{t} \}}_{t = 1}^{{N}_{i}}$$

represent the unit impulse functions located at different input pixels. The all-optical output intensity vectors

$${\{ {o}_{t}^{′} \}}_{t = 1}^{{N}_{i}}$$

corresponding to these input intensity vectors were simulated and stacked column by column, i.e.,

$${A}^{′} = [ {o}_{1}^{′} \vert {o}_{2}^{′} \vert ⋯ \vert {o}_{{N}_{i}}^{′} ] \qquad ( 20 )$$

The loss function was defined as:

$${ℒ}_{PSF} = \frac{1}{{N}_{i} {N}_{o}} {\sum }_{q = 1}^{{N}_{i}} {\sum }_{p = 1}^{{N}_{o}} {( A [ p , q ] - {σ}_{A}^{′} {A}^{′} [ p , q ] )}^{2} \qquad ( 21 )$$

$$where$$

$${σ}_{A}^{′} = \frac{{\sum }_{q = 1}^{{N}_{i}} {\sum }_{p = 1}^{{N}_{o}} A [ p , q ] {A}^{′} [ p , q ]}{{\sum }_{q = 1}^{{N}_{i}} {\sum }_{p = 1}^{{N}_{o}} {( {A}^{′} [ p , q ] )}^{2}} \qquad ( 22 )$$

### Other Training Details

The height h of the diffractive features at each layer 12 was confined between zero and a maximum value hₘₐₓ by using a latent variable hₗₐₜₑₙₜ:

$$h = \frac{{h}_{max}}{2} \times [ sin ( {h}_{latent} ) + 1 ] \qquad ( 23 )$$

$${h}_{max} \approx \frac{λ}{n - 1}$$

was chosen so that the corresponding phase modulation depth is 2π. The latent variables were initialized randomly from the standard normal distribution [symbol] (0,1). In the indirect and the direct design approaches that are data-driven, the diffractive layers 12 were optimized using the AdamW optimizer for 50 epochs with a minibatch size of 8 and an initial learning rate of 10⁻³. The learning rate was decayed by a factor of 0.7 every five epochs. The mean loss of the trained model on the validation set was evaluated after the completion of each epoch and selected the trained model state at the end of the epoch corresponding to the lowest validation loss. These details were the same for both the indirect and the direct training approaches. For the PSF-based data-free design approach, the diffractive layers 12 were optimized using the AdamW optimizer for 12,000 iteration steps with an initial learning rate of 10⁻¹. The learning rate was decayed by a factor of 0.5 if the loss did not decrease for 20 iteration steps, using the PyTorch built-in class: torch.optim.lr_scheduler.ReduceLROnPlateau.

The diffractive processor models were implemented and trained using PyTorch (v1.10) with Compute Unified Device Architecture (CUDA) version 11.3.1. Training and testing were done on GeForce RTX 3090 graphics processing units (GPU) in workstations with 256 GB of random-access memory (RAM) and Intel Core i9 central processing unit (CPU). The training time of the models varied with the training approach as well as the size of the models in terms of K and N. For example, the indirect training of K=5, N=5×52² diffractive network model took less than 2 hours, whereas with the direct approach, the training time for the K=5, N=5×52² model with N_{φ,tr}=1000 was around 10 days. With the PSF-based data-free design approach, all the 12,000 update steps took in total <4 min (FIGS. 21A-21B).

### Evaluation

The evaluation procedure was the same across all the trained diffractive networks 10 irrespective of whether the direct approach or the indirect approach was used to train them. To evaluate the trained diffractive networks, a test set comprising 20,000 pairs of input and target intensity vectors o=Ai was generated. Note that these 20,000 test examples were generated using a different random seed from the ones used to generate the training and the validation sets to ensure they were not represented during the training. For a given i, the corresponding input intensity pattern was incoherently propagated through the trained diffractive network (as in Eq. 15) using N_{φ,te}=20,000 to compute the output intensity o′. The mean of the error between o′ and o (Eq. 18) over the 20,000 test examples was used to quantify the output error of the diffractive network for comparing different designs, as in FIGS. 1 and 6. For comparison between the ground truth and the all-optical output intensities, e.g., in FIGS. 3, 4, 8, 9, 10, the scaled all-optical output intensity vector was defined as

$$\hat{o} = \frac{{σ}^{′}}{σ} {o}^{′} ,$$

where the definitions of σ and σ′ are as described in Eq. 19.

The intensity transformation A′ performed by the spatially incoherent diffractive network 10 at the end of its training was evaluated following Eq. 20. However, considering the diffraction-efficiency-associated scaling mismatch between A′ and the target transformation A, the scaled diffractive network intensity transformation was defined as Â=σ_{A}A′, where:

$${σ}_{A} = \sqrt{\frac{{\sum }_{q = 1}^{{N}_{i}} {\sum }_{p = 1}^{{N}_{o}} {( A [ p , q ] )}^{2}}{{\sum }_{q = 1}^{{N}_{i}} {\sum }_{p = 1}^{{N}_{o}} {( {A}^{′} [ p , q ] )}^{2}}} \qquad ( 24 )$$

This definition of σ_{A} makes the 2-norms of A and Â equal.

### Diffractive Optical Network Training for Multi-Wavelength Spatially Incoherent Illumination

The indirect design approach was used for training diffractive networks 10 to perform wavelength-multiplexed intensity linear transformations under spatially incoherent illumination. The loss function [symbol] was defined as:

$$ℒ = \frac{1}{{N}_{w}} {\sum }_{w = 1}^{{N}_{w}} {α}_{w} {ℒ}_{indirect , w} \qquad ( 25 )$$

Here N_{w}=3 is the number of wavelength channels used and [symbol] _{indirect,w} is the MSE loss as defined in Eq. 16, computed using the target output field õ_{w}=A̅_{w}ĩ_{w} and the all-optical output field

$${\tilde{o}}_{w}^{′}$$

at wavelength λ_{w}; the associated normalization factors σ̅_{w} and

$${\overline{\overline{σ}}}_{w}^{′}$$

were defined similarly as in Eq. 17. To clarify, A̅_{w}[p, q]=\sqrt{A_{w}[p, q]} exp(j0) where A_{w} is the target intensity linear transformation at the wavelength λ_{w}.

Adaptive spectral weight coefficients α_{w} were used to balance the performance across the wavelength channels. The initial values of α_{w} were set as 1 for all w, and updated after each training step according to the following rule:

$${α}_{w} ← max ( 0.1 \times ( {ℒ}_{indirect , w} - {ℒ}_{indirect , 0} ) + {α}_{w} , 0 ) \qquad ( 26 )$$

The refractive indices n_{w} of the diffractive layer material at the terahertz wavelengths λ₁=700 μm, λ₂=750 μm and λ₃=800 μm were assumed to be 1.7258, 1.7224 and 1.7194, respectively. The maximum layer height hyperparameter hₘₐₓ was set as 1.2 mm and the diffractive layer feature size was assumed to be 0.4 mm.

### Spatially Incoherent Diffractive Network Training for Image Classification

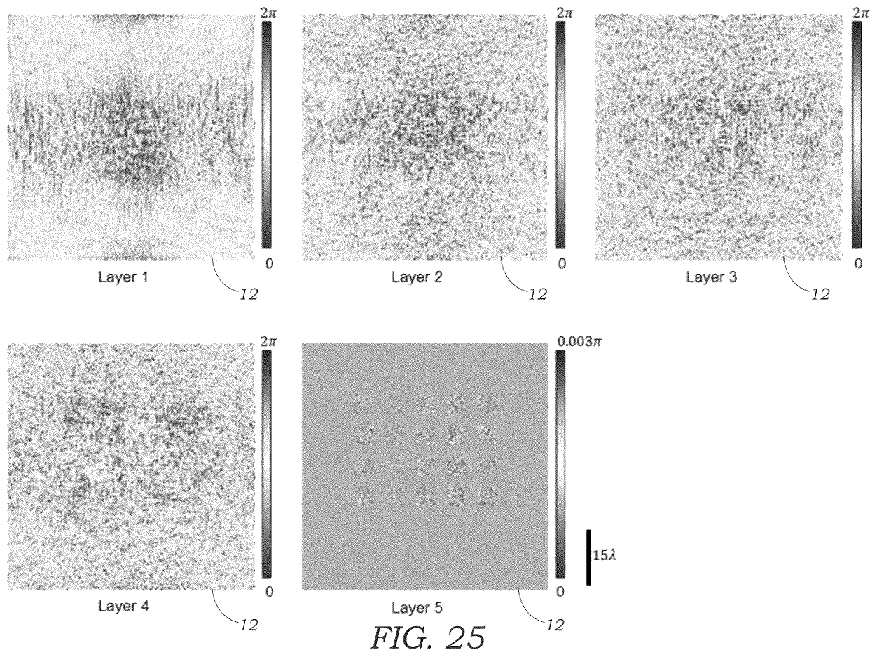

For the all-optical image classification task reported in FIGS. 22A-22B, the numerical simulations were performed in the visible range, where λ=490 nm was used and a diffractive feature size of 200 nm to emulate incoherent visible light in natural scenes. The MNIST handwritten digit images were normalized to [0-1] and upsampled to 80×80 pixels. The diffractive network comprised 5 phase-only diffractive layers (FIG. 25), each containing 160×160 diffractive features. At the output plane of the diffractive network, 20 detectors were arranged in a differential scheme, i.e., a “positive” detector and a “negative” detector were used for each of the 10 data classes. An example of the arrangement of the detectors in the differential scheme may be found in U.S. Patent Application Publication No. 2022/0327371, which is incorporated by reference herein. The computational window size was set to 512×512.

For image classification, the differential class scores were computed as:

$${s}_{c} = \frac{{I}_{c , +} - {I}_{c , -}}{{I}_{c , +} + {I}_{c , -}} \qquad ( 27 )$$

Here, I_{c,+} and I_{c,-} are the integrated intensity over the positive and negative detectors, corresponding to data class c. The class corresponding to the maximum s_{c} was selected as the inferred object class.

The spatially incoherent diffractive network classifier of FIGS. 22A-22B was trained using the cross-entropy loss, i.e.,

$$ℒ = - {\sum }_{c = 0}^{9} {δ}_{ck} log \frac{exp ( β {s}_{c} )}{{\sum }_{i = 0}^{9} exp ( β {s}_{i} )} \qquad ( 28 )$$

Here k is the ground truth label and δ_{ck} is the Kronecker delta function. β=10 is a training hyperparameter. In the training, N_{φ,tr}=10 was used with a batch size of 64. The diffractive network was trained for 500 epochs with AdamW optimizer initiated with a learning rate of 10⁻⁴. The final model was selected based on the validation accuracy with N_{φ,tr}=10. After the training, the selected model was blindly tested using N_{φ,te}=20,000, which resulted in a classification test accuracy of 95.04% (see FIGS. 22A-22B).

### Linear Transformation Matrix (Complex-Valued Linear Transformations)

Here, Nᵢ=Nₒ=16 was used so that A∈ [symbol] ^{16×16}; see FIG. 27B. To generate A, the amplitude of each element was randomly sampled from the uniform distribution Uniform(0,1) and the phases from Uniform(0,2π). For the encryption application, to ensure that the result of inversion is not sensitive to small errors, QR-factorization was performed on A to obtain a condition number of one.

### Real-Valued Non-Negative Representation of Complex Numbers (Complex-Valued Linear Transformations)

Following Eq. 9, the complex-valued input and target vectors i∈ [symbol] ^{N}^{ᵢ} and o∈ [symbol] ^{N}^{ₒ} are represented by the corresponding real and non-negative intensity vectors

$${i}_{r} = {[ \begin{matrix}{i}_{0}^{T} & … & {i}_{E - 1}^{T}\end{matrix} ]}^{T} ∈ {\text{?}}_{+}^{{EN}_{i}} and {o}_{r} = {[ \begin{matrix}{o}_{0}^{T} & … & {o}_{E - 1}^{T}\end{matrix} ]}^{T} ∈ {\text{?}}_{+}^{{EN}_{o}} , \\ where i = {\sum }_{k = 0}^{E - 1} {e}_{k} {i}_{k} and o = {\sum }_{k = 0}^{E - 1} {e}_{k} {o}_{k} .$$

The desired all-optical intensity transformation Aᵣ between iᵣ and oᵣ is derived from the target complex-valued linear transformation A following Eqs. 6 and 10. It should be noted that deriving Aᵣ from A requires mapping each complex element a to its real and non-negative representation (aₒ, . . . , a_{E-1}) based on the E≥3 complex bases eₖ such that

$$a = {\sum }_{k = 0}^{E - 1} {e}_{k} {a}_{k} .$$

To define a unique mapping, the algorithm in J. W. Goodman et al., “Method for performing complex-valued linear operations on complex-valued data using incoherent light,” Appl. Opt., AO 16 (10), 2611-2612, Optica Publishing Group (1977), which is incorporated by reference herein, was used by imposing additional constraints:

$${a}_{k} = 0 if \frac{2 π}{E} \leq phase ( {e}_{k} {a}^{*} ) \leq 2 π - \frac{2 π}{E} ,$$

i.e., aₖ=0 if the angle between a and eₖ is greater than

$$\frac{2 π}{E} ;$$

here a* represents the complex conjugate of a. The same constraints were also used while mapping the complex input vectors i to the real and non-negative intensity vectors iᵣ.

### Mosaicing and Demosaicing Schemes (Complex-Valued Linear Transformations)

For mosaicing (demosaicing) assignment of each element of iᵣ (oᵣ) to one of the N_{i,r}=ENᵢ (N_{o,r}=ENₒ) pixels of the 2D input (output), the arrangement of the FOV can be regular, e.g., in a row-major order as shown in FIG. 33A, ‘Regular mosaicing’. Alternatively, the pixel assignment on the input (output) FOV can follow any arbitrary mapping which can be defined by a permutation matrix Pᵢ (Pₒ) operating on the input (output) vector; see FIG. 33A, ‘Arbitrary mosaicing’. For such cases, when ordered in a row-major format, intensities on the input (output) FOVs iᵣ (oᵣ) can be written as

$${i}_{r} = {{P}_{i} [ \begin{matrix}{i}_{0}^{T} & … & {i}_{E - 1}^{T}\end{matrix} ]}^{T} ( {o}_{r} = {{P}_{o} [ \begin{matrix}{o}_{0}^{T} & … & {o}_{E - 1}^{T}\end{matrix} ]}^{T} ) .$$

Accordingly, such an arbitrary arrangement of pixels was accounted for by redefining the all-optical intensity transformation as

$${P}_{o} {A}_{r} {P}_{i}^{T} .$$

### Spatially Incoherent Light Propagation Through a Diffractive Optical Network or Processor (Complex-Valued Linear Transformations)

The ID vector iᵣ is rearranged as a 2D distribution of intensity I(x, y) at the input FOV of the diffractive optical network or processor 10. To numerically model the spatially incoherent propagation of the input intensity distribution I(x, y) through the diffractive optical network or processor 10, the optical field \sqrt{I} exp(jφ) was coherently propagated through the trainable diffractive surfaces to the output plane, where φ is a random 2D phase distribution, i.e., φ(x, y)~Uniform(0, 2π) for all (x, y). If one denotes the coherent field propagation operator as [symbol] {·} (see the next subsection), then the instantaneous output intensity is | [symbol] {\sqrt{I(x, y)} exp(jφ(x, y))}|² and the time-averaged output intensity O(x, y) for spatially incoherent light can be written as:

$$O ( x , y ) = 〈 {\vert \text{?} \{ \sqrt{I ( x , y )} exp ( j φ ( x , y ) ) \} \vert}^{2} 〉 \qquad ( 29 )$$

The average output intensity can be approximately calculated by repeating the coherent wave propagation [symbol] {·} N_{φ}-times, each time with a different random phase distribution φᵣ(x, y), and averaging the resulting N_{φ} output intensities:

$$O ( x , y ) = {lim}_{{N}_{φ} \to ∞} \frac{1}{{N}_{φ}} {\sum }_{r = 1}^{{N}_{φ}} {\vert \text{?} \{ \sqrt{I ( x , y )} exp ( j {φ}_{r} ( x , y ) ) \} \vert}^{2} \qquad ( 30 )$$

N_{φ}=20,000 was used for estimating the incoherent output intensity O(x, y) corresponding to any arbitrary input intensity I(x, y). Note that when only one pixel at the input aperture is activated, with all other input pixels being inactive with zero intensity, as is the case while evaluating spatially varying PSFs, the application of Eq. 30 becomes redundant, although one could still use it. In this scenario, all the light diffracted from a single point source is mutually coherent. Consequently, for the purposes of evaluating the spatially varying PSFs of the system, as elaborated later in the subsection ‘Training and evaluation of spatially incoherent diffractive processors’, employing a coherent propagation model for each point emitter at the input aperture is accurate and provides a faster solution.

Coherent Propagation of Optical Fields: [symbol] {·} (Complex-Valued Linear Transformations)

The propagation of spatially coherent light patterns through a diffractive processor 10, denoted by [symbol] {·}, involves a series of interactions with consecutive diffractive surfaces/layers 12, interleaved by wave propagation through the free-space separating these surfaces. It is assumed that these modulations are introduced by phase-only diffractive surfaces, i.e., the field amplitude remains unchanged during the light-matter interaction. Specifically, it is assumed that a diffractive surface/layers 12 alters the incident optical field, symbolized as u(x, y), in a localized manner according to the optimized phase values φ_{M} (x, y) of the diffractive features, resulting in the phase-modulated field u(x, y)exp(jφ_{M}(x, y)). The diffractive surfaces 12 are coupled by free-space propagation, allowing the light to travel from one surface to the next. The angular spectrum method was to simulate the free-space propagation:

$$u ( x , y ; z = {z}_{0} + d ) = {ℱ}^{- 1} \{ ℱ \{ u ( x , y ; z = {z}_{0} ) \} \times H ( {f}_{x} , {f}_{y} ; d ) \} \qquad ( 31 )$$

where [symbol] {·} is the two-dimensional Fourier transform and [symbol] ⁻¹{·} is its inverse operation. H(ƒₓ, ƒ_{y}; d) is the free-space transfer function corresponding to propagation distance d. For wavelength λ:

$$H ( {f}_{x} , {f}_{y} ; d ) = \{ \begin{matrix}exp ( j \frac{2 π}{λ} d \sqrt{1 - {( λ {f}_{x} )}^{2} - {( λ {f}_{y} )}^{2}} ) , & {f}_{x}^{2} + {f}_{y}^{2} < 1 / {λ}^{2} \\ 0 , & otherwise\end{matrix} \qquad ( 32 )$$

The fields were discretized with a lateral sampling interval of δ≈0.53λ to accommodate all the propagating modes and sufficiently zero-padded to remove aliasing artifacts.

### Diffractive Network Architecture (Complex-Valued Linear Transformations)

The diffractive surfaces (i.e., layers 12) were modeled by their laterally discretized heights h, which correspond to phase delays

$${φ}_{M} = \frac{2 π}{λ} ( n - 1 ) h ,$$

where n is the refractive index of the material. The connectivity between consecutive diffractive layers 12 was kept equal across the diffractive designs with varying N by setting the separation between the layers 12 as

$$d = \frac{W δ}{λ} ,$$

where the width of each diffractive layer 12 is

$$W = \sqrt{\frac{N}{K}} δ .$$

Here K is the number of diffractive layers 12; K=4 was used.

### Training and Evaluation of Spatially Incoherent Diffractive Processors (Complex-Valued Linear Transformations)

For performing an arbitrary complex-valued linear transformation with a diffractive processor 10, the PSF-based data-free design approach was used, where the diffractive features 24 were optimized so that the all-optical intensity transformation of the diffractive processor 10 achieves [symbol] ≈Aᵣ. To evaluate [symbol] ENᵢ intensity vectors

$${\{ {i}_{r , t} \}}_{t = 1}^{{EN}_{i}}$$

were used where i_{r,t}[l]=1 if l=t and 0 otherwise. In other words,

$${\{ {i}_{r , t} \}}_{t = 1}^{{EN}_{i}}$$

are unit impulses, located at different input pixels. The all-optical output intensity vectors

$${\{ {o}_{r , t}^{′} \}}_{t = 1}^{{EN}_{i}}$$

corresponding to these unit impulses were simulated and stacked, i.e.,

$$\text{?} = [ {o}_{r , 1}^{′} \vert {o}_{r , 2}^{′} \vert … \vert {o}_{r , {EN}_{i}}^{′} ] \qquad ( 33 )$$

Finally, the optical diffraction efficiency-related scale mismatch was compensated for through multiplication by a scalar, i.e.,

$$\text{?} = σ \text{?} \qquad ( 34 )$$

where σ was defined as:

$$σ = \frac{{\sum }_{m = 1}^{{EN}_{i}} {\sum }_{n = 1}^{{EN}_{o}} {A}_{r} [ m , n ] \text{?} [ m , n ]}{{\sum }_{m = 1}^{{EN}_{i}} {\sum }_{n = 1}^{{EN}_{o}} {( \text{?} [ m , n ] )}^{2}} \qquad ( 35 )$$

The MSE loss function to be minimized was defined as:

$${ℒ}_{PSF} = \frac{1}{{N}_{i} {N}_{o}} {\sum }_{n = 1}^{{EN}_{i}} {\sum }_{m = 1}^{{EN}_{o}} {( {A}_{r} [ m , n ] - \text{?} [ m , n ] )}^{2} \qquad ( 36 )$$

The height h of the diffractive features at each layer was constrained between zero and a maximum value hₘₐₓ by employing a latent variable hₗₐₜₑₙₜ. The relationship between the constrained height h and the latent variable hₘₐₓ was defined as:

$$h = \frac{{h}_{max}}{2} \times [ sin ( {h}_{latent} ) + 1 ] , where {h}_{max} \approx \frac{λ}{n - 1}$$

was chosen which corresponds to a differential phase modulation of 2π. The latent variables were initialized randomly from the standard normal distribution [symbol] (0,1).

The optimization of the diffractive layers 12 was carried out using the AdamW optimizer for 12000 iterations with an initial learning rate of 10⁻³. The model state corresponding to the minimum of the MSEs evaluated after every 400 iterations was selected for the final evaluation. The diffractive processor models were implemented and trained using PyTorch (v1.12.1) with Compute Unified Device Architecture (CUDA) version 12.2. Training and testing were done on GeForce RTX 3090 graphics processing units (GPU) in workstations with 256 GB of random-access memory (RAM) and Intel Core i9 central processing unit (CPU). The training time of the models varied with the size of the models. For example, the model used in FIGS. 28B, 28C took around 1 hour for 12000 iterations. Inference for each input vector with N_{φ}=20000 takes around 30 seconds.

To visualize the all-optical transformation error in FIG. 28C, the error matrix εᵣ=(Aᵣ− [symbol] )² was used; here (·)² denotes an elementwise operation. To evaluate the error ε at complex linear transformation, demosaicing was applied to the columns of [symbol] to form the block matrix [ [symbol] | . . . | [symbol] ]∈ [symbol] ^{N}^{ₒ}^{×EN}^{ᵢ}. Here the subscript k represents that [symbol] is measured by applying the columns of eₖI as input, and stacking the corresponding demosaiced (complex-valued) output vectors. Accordingly, one has

$${ε = \vert [ {e}_{0} A - \text{?} \vert … \vert {e}_{E - 1} A - \text{?} ] \vert}^{2} \qquad ( 37 )$$

Here |·|² represents an elementwise operation.

### Entropy Evaluation (Complex-Valued Linear Transformations)

For the evaluation of the image encryption strength, the entropy was computed separately for the real and imaginary parts of a complex image as follows:

$${H}^{Re / Im} ( x ) = - {\sum }_{i} {p}_{i}^{\frac{Re}{Im}} \cdot log ( {p}_{i}^{\frac{Re}{Im}} ) \qquad ( 38 )$$

where the distribution of either the real or imaginary part (denoted by the superscript) over the pixels of x was calculated; here x denotes the complex image. pᵢ is the probability (normalized histogram count) for a certain pixel value i.

For the histograms presented in FIG. 32B, the dataset is adapted from the Extended MNIST (EMNIST). For the creation of the input complex images, two distinct images from the EMNIST dataset were randomly selected, using one as the real part and the other as the imaginary part of the complex image. To ensure compatibility with the input dimensionality, these images were bilinearly downsampled to a resolution of 4×4 pixels. A set of 1,000 such complex images was randomly formed to compile the histograms presented in FIG. 32B.

While embodiments of the present invention have been shown and described, various modifications may be made without departing from the scope of the present invention. The invention, therefore, should not be limited, except to the following claims, and their equivalents.

1. A diffractive optical network or processor comprising:
a plurality of optically transmissive and/or reflective substrate layer(s) arranged in an optical path, each of the optically transmissive and/or reflective substrate layer(s) comprising a plurality of physical features formed on or within the one or more optically transmissive or reflective substrate layer(s) and having different transmission and/or reflection properties as a function of lateral coordinates across each substrate layer, wherein the plurality of optically transmissive and/or reflective substrate layer(s) are configured to receive an input optical signal or data comprising spatially-incoherent and/or temporally-incoherent light and wherein the plurality of optically transmissive and/or reflective substrate layer(s) generate an output optical signal or data that approximates a target linear transformation of the input optical signal or data; and
wherein the plurality of optically transmissive and/or reflective substrate layer(s) are designed during a training phase with training intensity patterns or images to define or optimize the plurality of physical features formed on or within the one or more optically transmissive or reflective substrate layer(s) to generate the output optical signal or data that approximates the target linear transformation of the input optical signal or data.

2. The diffractive optical network or processor of claim 1, wherein the input optical signal or data and output optical signal or data comprise optical images.

3. (canceled)

4. The diffractive optical network or processor of claim 1, wherein the spatially-incoherent and/or temporally-incoherent light comprises one or more wavelengths or a spectral band of interest.

5. The diffractive optical network or processor of claim 1, wherein the spatially-incoherent and/or temporally-incoherent light comprises x-rays, visible light, infrared light, terahertz or longer wavelengths of the electromagnetic spectrum.

6. The diffractive optical network or processor of claim 1, further comprising one or more image sensors or optoelectronic detectors disposed along the optical path and configured to receive and/or record the output optical signal or data.

7. The diffractive optical network or processor of claim 1, wherein the output optical signal or data is projected onto a surface, a volume, a display, a goggle, or an eye.

8. The diffractive optical network or processor of claim 1, wherein the plurality of optically transmissive and/or reflective substrate layer(s) comprise between 1 and 10 optically transmissive layers.

9. The diffractive optical network or processor of claim 1, wherein the plurality of optically transmissive and/or reflective substrate layer(s) satisfy N≥2NᵢNₒ, where (N) is a total number of optimizable phase-only diffractive features and wherein Nᵢ refers to a number of useful pixels at an input field-of-view (FOV) containing the input optical signal or data and wherein N_{φ} refers to a number of useful pixels at an output FOV containing the output optical signal or data.

10. The diffractive optical network or processor of claim 1, wherein training phase comprises digitally training a model of the diffractive optical network or processor using machine learning to directly approximate the target linear transformation with a plurality of training input optical signals or data comprising spatially-incoherent light and/or temporally-incoherent light.

11. The diffractive optical network or processor of claim 1, wherein training phase comprises digitally training a model of the diffractive optical network or processor using machine learning to indirectly approximate the target linear transformation with a plurality of training input optical signals or data comprising spatially-coherent light.

12. The diffractive optical network or processor of claim 1, wherein the diffractive optical network or processor is disposed in an optical path of a microscope, imaging system, camera, telescope, sensor, or endoscope.

13. A method of using a diffractive optical network or processor comprising:
providing a plurality of optically transmissive and/or reflective substrate layer(s) arranged in an optical path, each of the optically transmissive and/or reflective substrate layer(s) comprising a plurality of physical features formed on or within the one or more optically transmissive or reflective substrate layer(s) and having different transmission and/or reflection properties as a function of lateral coordinates across each substrate layer, wherein the plurality of optically transmissive and/or reflective substrate layer(s) are configured to receive an input optical signal or data comprising spatially-incoherent and/or temporally-incoherent light and wherein the plurality of optically transmissive and/or reflective substrate layer(s) generate an output optical signal or data that approximates a target linear transformation of the input optical signal or data; and
inputting the input optical signal or data to the plurality of optically transmissive and/or reflective substrate layer(s); and
capturing the output optical signal or data with one or more image sensors or optoelectronic detectors or projecting the output optical signal onto a surface or volume.

14. The method of claim 13, wherein the input optical signal or data and output optical signal or data comprise optical images.

15. (canceled)

16. The method of claim 13, wherein the spatially-incoherent and/or temporally-incoherent light comprises one or more wavelengths or a spectral band of interest.

17. The method of claim 13, wherein the spatially-incoherent and/or temporally-incoherent light comprises x-rays, visible light, infrared light, terahertz or longer wavelengths of the electromagnetic spectrum.

18. The method of claim 13, wherein the surface or volume comprises an eye, a display, or a goggle.

19. The method of claim 13, wherein the plurality of optically transmissive and/or reflective substrate layer(s) comprise between 1 and 10 optically transmissive layers.

20. The method of claim 13, wherein the plurality of optically transmissive and/or reflective substrate layer(s) satisfy N ≥2NᵢNₒ, where (N) is a total number of optimizable phase-only diffractive features and wherein Nᵢ refers to a number of useful pixels at an input field-of-view (FOV) containing the input optical signal or data and wherein N_{φ} refers to a number of useful pixels at an output FOV containing the output optical signal or data.

21. The method of claim 13, wherein the diffractive optical network or processor is disposed in an optical path of a microscope, imaging system, camera, telescope, sensor, or endoscope.

22. The method of claim 13, wherein the input optical signal or data comprises a plurality of different wavelengths or wavelength bands and wherein the plurality of optically transmissive and/or reflective substrate layer(s) simultaneously generate output optical signals or data that approximate a plurality of target linear transformations of the input optical signal or data where each one of the different wavelengths or wavelength bands is assigned to one target linear transformation.

23. A diffractive optical network or processor for performing a complex-valued target linear transformation of an input optical signal or data comprising:
a plurality of optically transmissive and/or reflective substrate layer(s) arranged in an optical path, each of the optically transmissive and/or reflective substrate layer(s) comprising a plurality of physical features formed on or within the one or more optically transmissive or reflective substrate layer(s) and having different transmission and/or reflection properties as a function of lateral coordinates across each substrate layer, wherein the plurality of optically transmissive and/or reflective substrate layer(s) are configured to receive input optical signal(s) or data comprising spatially-incoherent light that maps complex-valued data to an optical intensity-based representation at an input field-of-view (FOV) of the diffractive optical network and wherein the plurality of optically transmissive and/or reflective substrate layer(s) generate encrypted output optical signal(s) or data at an output field-of-view (FOV);
one or more image sensors or optoelectronic detectors disposed at the output field-of-view and configured to receive the output optical signal(s) or data at the output FOV; and
a computing device or circuitry configured to map intensity data obtained by the one or more image sensors or optoelectronic detectors at the output FOV into a complex-valued signal(s) or data that approximate the target linear transformation of the input optical signal(s) or data.

24. The diffractive optical network or processor of claim 23, wherein the plurality of optically transmissive and/or reflective substrate layer(s) are designed during a training phase with training intensity patterns or images to define or optimize the plurality of physical features formed on or within the one or more optically transmissive or reflective substrate layer(s) to generate the output optical signal(s) or data that approximate the target linear transformation of the input optical signal(s) or data.

25. The diffractive optical network or processor of claim 23, wherein the plurality of optically transmissive and/or reflective substrate layer(s) are designed during a data-free training phase that optimizes the plurality of physical features to perform all optical intensity transformation [symbol] at the output FOV relative to a ground truth Aᵣ such that [symbol] ≈Aᵣ.

26. The diffractive optical network or processor of claim 23, wherein the plurality of optically transmissive and/or reflective substrate layer(s) encrypt the input optical signal(s) or data with a complex-valued transformation matrix A and wherein the computing device or circuitry is configured to map intensity data obtained by the one or more image sensors using A⁻¹.

27. The diffractive optical network or processor of claim 23, wherein the input optical signal(s) or data comprise images.

28. The diffractive optical network or processor of claim 23, wherein the spatially-incoherent light comprises x-rays, visible light, infrared light, terahertz or longer wavelengths of the electromagnetic spectrum.

29. (canceled)

30. A diffractive optical network or processor for performing a complex-valued target linear transformation of an input optical signal or data comprising:
a plurality of optically transmissive and/or reflective substrate layer(s) arranged in an optical path, each of the optically transmissive and/or reflective substrate layer(s) comprising a plurality of physical features formed on or within the one or more optically transmissive or reflective substrate layer(s) and having different transmission and/or reflection properties as a function of lateral coordinates across each substrate layer, wherein the plurality of optically transmissive and/or reflective substrate layer(s) are configured to receive a digitally encrypted complex optical image comprising spatially-incoherent light that maps complex-valued data to an optical intensity-based representation at an input field-of-view (FOV) of the diffractive optical network and wherein the plurality of optically transmissive and/or reflective substrate layer(s) generate a decrypted output optical signal or data at an output field-of-view (FOV);
one or more image sensors or optoelectronic detectors disposed at the output field-of-view and configured to receive the output optical signal or data at the output (FOV); and
a computing device or circuitry configured to map intensity data obtained by the one or more image sensors or optoelectronic detectors at the output FOV into complex-valued signal(s) or data that approximate the target linear transformation of the input optical signal or data.

31. The diffractive optical network or processor of claim 30, wherein the plurality of optically transmissive and/or reflective substrate layer(s) are designed during a training phase with training intensity patterns or images to define or optimize the plurality of physical features formed on or within the one or more optically transmissive or reflective substrate layer(s) to generate the output optical signal or data that approximate the target linear transformation of the input optical signal or data.

32. The diffractive optical network or processor of claim 30, wherein the plurality of optically transmissive and/or reflective substrate layer(s) are designed during a data-free training phase that optimizes the plurality of physical features to perform all optical intensity transformation [symbol] at the output FOV relative to a ground truth Aᵣ such that [symbol] ≈Aᵣ.

33. The diffractive optical network or processor of claim 30, wherein the input optical signal or data comprises a plurality of images.

34. The diffractive optical network or processor of claim 30, wherein the spatially-incoherent light comprises x-rays, visible light, infrared light, terahertz or longer wavelengths of the electromagnetic spectrum.

35. (canceled)
